(19) United States
(12) Patent Application Publication
(10) Pub. No.: US 2012/0047098 A1
(43) Pub. Date: Feb. 23, 2012

(54) METHOD FOR COMPUTING AND STORING VORONOI DIAGRAMS, AND USES THEREFOR

(76) Inventor: Daniel REEM, Kfar-Vradim (IL)

(21) Appl. No.: 13/212,228

(22) Filed: Aug. 18, 2011

Related U.S. Application Data
(60) Provisional application No. 61/375,071, filed on Aug. 19, 2010.

(51) Int. Cl. G06F 15/18

(52) U.S. Cl. 706/12

(57) ABSTRACT

A method of producing and storing a Voronoi diagram includes: a) selecting a desired site Pₖ and a desired point p in the site; b) selecting a plurality of subfaces corresponding to a manifold around said point p; c) for each desired subface selecting a plurality of directions; d) for each direction providing a ray, selecting a point on the ray as an endpoint, and selecting hyperplanes corresponding to the endpoints; e) for each desired subface determining a type of intersection between the detected hyperplanes; f) determining whether there exist vertices of the cell in a cone generated by the endpoints, and finding said vertices, wherein if there remain further vertices that have not been found then there is carried out a step of further dividing the said subface into additional subfaces for separate determination; g) storing at least one of the following: said vertices, hyperplanes, neighbor sites, and possibly other information such as endpoints; h) repeating a)-g) for each desired site Pₖ and each desired point p in the selected site; i) defining at least one vertex or hyperplane from said endpoints, thereby decomposing said region X; and j) outputting said decomposed region X.

### RELATIONSHIP TO EXISTING APPLICATIONS

This application claims the benefit of priority under 35 USC 119(e) of U.S. Provisional Patent Application No. 61/375,071 filed Aug. 19, 2010, the contents of which are incorporated herein by reference in their entirety.

### FIELD AND BACKGROUND OF THE INVENTION

The present invention relates to a method for computing and storing Voronoi diagrams and to uses thereof in technology and, more particularly, but not exclusively to uses thereof in communications networks, in robotics, in three-dimensional networks, in materials science, in molecular biology, in searching of data, in a way of providing overall control of a variety of methods for applications such as image processing, data categorization, numerical simulations, meshing, solid modelling, clustering etc, efficient designs of electronic circuits, for management of geographical information systems, efficient location problems, face recognition and image recognition in general, as an artistic tool, and as a programming tool.

Voronoi diagrams are one of the basic structures in computational geometry. Roughly speaking, they are a certain decomposition of a given space into cells, induced by a distance function and by a tuple of subsets, called the generators or the sites. More precisely, given a collection of sites, a Voronoi cell corresponding to some site Pₖ is the set of all the points whose distance to Pₖ is not greater than their distance to the union of the other sites Pⱼ.

Voronoi diagrams appear in a large number of fields in science and technology and have many applications. One can find applications in chemistry, biology, archeology, mathematics, physics, computer graphics, image processing, computational geometry, crystallography, geography, metallography, economics, art, computer science, astronomy, linguistics, robotics, communication and many more areas. A very simple example which illustrates the concept of a Voronoi diagram is a collection of competing shops in a two-dimensional city. Each shop is represented by a point, and the Voronoi cell associated with it is its domain of influence: the region composed of all the points whose distance to this specific shop is not greater than their distance to the other shops. An illustration is given in FIGS. 1 and 2. As a result of the above, it can be seen that finding methods for computing Voronoi diagrams is an important task.

There are many methods for computing Voronoi diagrams, but they suffer from several limitations. They suffer from degenerate cases and their implementation is complicated in many cases. Their computation time can grow significantly when the number of sites grows. Most of them are limited to the computation of diagrams of point sites, and cannot compute diagrams whose sites consist of many points. In addition, most of them are not able to compute a specific cell independently of the other cells, and this obviously imposes serious limitation on the possibility of parallel implementation.

Some time ago the present inventor developed a general method for computing Voronoi diagrams, this being disclosed in U.S. patent application Ser. No. 12/461,216, the contents of which are hereby incorporated herein by reference.

### SUMMARY OF THE INVENTION

The present embodiments improve significantly upon the general method related to above, in the particular but important case of the Euclidean distance. In addition, the present embodiments allow for retrieving and storing in a convenient way the combinatorial information relating to the diagram, which was problematic in the previous method.

According to one aspect of the present invention there is provided a computerized method of decomposing a given region X into cells, the decomposition being induced by a set of sites P₁, . . . , Pₙ, and a distance function d, and finding for each desired site Pₖ a cell, the cell comprising a set of all the points in X satisfying a distance inequality condition, based on said distance function, the inequality of the condition being that the distance of a respective point to said site Pₖ is not greater than the distance of said respective point to the union of the other sites, the method being carried out on an electronic processor and comprising:

a) selecting a desired site Pₖ and a desired point p in this site;

b) selecting a plurality of subfaces corresponding to a manifold around said point p;

c) for each desired subface selecting a plurality of directions;

d) for each direction providing a ray, selecting a point on the ray as an endpoint, and selecting hyperplanes corresponding to the endpoints;

e) for each desired subface determining a type of intersection between the detected hyperplanes;

f) determining whether there exist vertices of the cell in a cone generated by the endpoints, and finding said vertices, wherein if there remain further vertices that have not been found then there is carried out a step of further dividing the said subface into additional subfaces for separate determination;

g) storing information relating to said vertices;

h) repeating a)-g) for each desired site Pₖ and each desired point p in the selected site;

i) defining at least one vertex or hyperplane from said endpoints, thereby decomposing said region X; and

j) outputting said decomposed region X in a machine readable format.

The method may further comprise providing the decomposed region for use in any of the following: controlling a communications network, managing a communication network, controlling a robot, managing a robot, modeling, testing or simulating a three-dimensional network, controlling a three-dimensional network, testing or modeling a material, data searching, searching for data on a network or database, image processing, mesh generation and re-meshing, curve and surface generation, curve and surface reconstruction, solid modeling, collision detection, controlling motion of vehicles, navigation, accident prevention, data clustering and data processing, proximity operations, nearest neighbor search, numerical simulations, weather prediction, analyzing or modeling proteins, analyzing or modeling crystal growth, analyzing or processing digital or analog signals, analyzing or modeling biological structures, designing drugs, finding shortest paths, pattern recognition, rendering, data compression, providing overall control of a plurality of methods for image processing, providing overall control of a plurality of methods for data categorization, providing overall control for a plurality of methods for data clustering, designing and testing of electronic circuits, management of geographic information systems, computing geometric objects, locating a resource according to the solution of an efficient location problem, face recognition, analyzing the behavior of populations, analyzing or modeling data related to astronomy, analyzing or modeling data related to geography, detecting or analyzing geometric structures, detecting or analyzing space structures, location based services, analyzing traffic, analyzing atmospheric data, analyzing oceanographic data, detecting or analyzing the distribution of matter in a region, detecting or analyzing the distribution of populations in a region, detecting or analyzing the distribution of energy in a region, and an artistic tool.

The method may involve, in step d), additionally selecting neighbour sites that correspond to said hyperplanes.

In an embodiment, said determining said type comprises examining a predetermined system of equations.

In an embodiment, said determining of vertices in said cone comprises further examining said predetermined system of equations.

In an embodiment, said manifold is a simplex.

In an embodiment, a subface to be selected is determined by one member of the group consisting of corners and unit vectors corresponding to said corners.

In an embodiment, said predetermined system of equations is of the general form

Bλ=H,

wherein:
m is the dimension of said region X;
θᵢ, i=1, . . . , m are said direction unit vectors;
p+Tᵢ is said endpoint in direction θᵢ;
Tᵢ=T(θᵢ,p)θᵢ is the vector whose direction is θᵢ and whose length is the distance
between said point p and said endpoint p+T_i;
L_i is the hyperplane corresponding to the endpoint p+Tᵢ;
Nᵢ is a normal to the hyperplane Lᵢ;
λ=(λ₁, . . . , λₘ) is a vector of unknowns;
B is an m by m matrix with Bᵢⱼ=<Nᵢ,Tⱼ>, i,j=1, 2, . . . , m; and
H=(H₁, . . . , Hₘ) is the vector with Hᵢ=<Nᵢ,Tᵢ>, i=1, 2, . . . , m.
In using the term “of the form”, it is intended to include all non-material transformations and variations of the formula that do not effect the way it works, including multiplication by a scalar.

The method may comprise:

computing respective vertices by solving said predetermined system of equations to obtain a solution λ=(λ₁, . . . , λₘ), and

checking if a corresponding vector u=p=λ₁T₁+ . . . λₘTₘ, comprising said vectors T₁, . . . , Tₘ and said point p, is in said cone and in said cell. wherein m is the dimension of said region X.

In an embodiment, said region X is of dimension two, wherein said dividing said given subface into additional subfaces comprises choosing an intermediate vector between respective corners of said subface to create two new subfaces, each new subface comprising said intermediate point and one of said corners, or vectors in a direction of said corners.

In an embodiment, said region X is of dimension two and wherein said deciding whether there are vertices of the cell in said cone generated by said endpoints comprises checking one member of the group consisting of:

a number of said hyperplanes,

whether there exist nonnegative solutions to said system of equations,

whether the determinant of said matrix B vanishes or not,

whether there are infinitely many solutions, a unique solution or no solution at all to said system of equations.

In an embodiment, said region X is of dimension three and said dividing said given subface into additional subfaces comprises dividing said subface into a partition of additional subfaces, where said partition is chosen from the following list of possible partitions:

no partition at all,

a small diameter partition′,

an interior point partition of type 0,

an interior point partition of type 1,

an interior point partition of type 2,

an interior point partition of type 3,

a boundary point partition of type 1,

a boundary point partition of type 2, and

a boundary point partition of type 3.

In an embodiment, said region X is of dimension three and said deciding whether there are vertices of the cell in said cone generated by said endpoints comprises one member of the group consisting of:

checking the number of different hyperplanes,

checking whether there exist nonnegative solutions to said system of equations,

checking whether said matrix B is of rank 1, or rank 2, or rank 3, or of rank smaller than the rank of another matrix B_{H}, or

checking whether there are infinitely many solutions, unique solution or no solution at all to said system of equations.

In an embodiment, the computations are carried out to a predetermined level of error parameters.

An embodiment may reuse cell calculations of earlier stages for saving calculations in later stages.

In an embodiment, said computation of a respective endpoint in a given direction θ comprises:

selecting a point y along the corresponding ray in direction θ, and moving and testing y recursively, and until a stopping condition is satisfied:

recursively testing comprises: selecting a point y along the ray emanating from p and in cases of y being either on the boundary of said region X or outside the cell of p; then if y is on the boundary, defining L as a corresponding hyperplane on which y is located and checking whether y is in said cell; and if y is in said cell, selecting y as an endpoint and defining L as the corresponding bisecting hyperplane on which y is located; and

wherein if y is neither within said cell of p nor on a boundary of region X, finding a corresponding point closer to y than to p, and determining an intersection u between the ray and a corresponding hyperplane L then setting y:=u, recursively testing until y is in said cell of p then setting y as the endpoint, said corresponding point being a closest neighbor site or a point in said closest neighbor site, and L being the corresponding bisecting hyperplane.

According to a second aspect of the present invention there is provided a computerized method for storing computed Voronoi cells and retrieving combinatorial information related to said cells to an electronic storage device, the method comprising:

storing, in said storage device, for each desired site Pₖ and each desired point p, data relating to a desired vertex u belonging to the cell of said point p together with data relating to an associated hyperplane; and

using said information to obtain information about said cells.

In an embodiment, said associated hyperplane is a hyperplane on which is located a face belonging to the cell of said point p.

In an embodiment, said data relating to desired vertex comprises the coordinates of said desired vertex and said data relating to said associated hyperplane comprises at least one member of the group comprising: associated neighbor sites, associated bisecting hyperplanes, associated faces located on said hyperplanes, and endpoints,

The method may comprise applying said combinatorial information to one member of the group comprising: controlling a communications network, managing a communication network, controlling a robot, managing a robot, modeling, testing or simulating a three-dimensional network, controlling a three-dimensional network, testing or modeling a material, data searching, searching for data on a network or database, image processing, mesh generation and re-meshing, curve and surface generation, curve and surface reconstruction, solid modeling, collision detection, controling motion of vehicles, navigation, accident prevention, data clustering and data processing, proximity operations, nearest neighbor search, numerical simulations, weather prediction, analyzing or modeling proteins, analyzing or modeling crystal growth, analyzing or processing digital or analog signals, analyzing or modeling biological structures, designing drugs, finding shortest paths, pattern recognition, rendering, data compression, providing overall control of a plurality of methods for image processing, providing overall control of a plurality of methods for data categorization, providing overall control for a plurality of methods for data clustering, designing and testing of electronic circuits, management of geographic information systems, computing geometric objects, locating a resource according to the solution of an efficient location problem, face recognition, analyzing the behavior of populations, analyzing or modeling data related to astronomy, analyzing or modeling data related to geography, detecting or analyzing geometric structures, detecting or analyzing space structures, location based services, analyzing atmospheric data, analyzing oceanographic data, detecting or analyzing the distribution of matter in a region, detecting or analyzing the distribution of populations in a region, detecting or analyzing the distribution of energy in a region, and an artistic tool.

The method may comprise finding, from said stored data, different neighbors of each site p; computing therefrom a Delaunay tessellation; and passing an edge between each site p and each of its different neighbor sites.

Unless otherwise defined, all technical and scientific terms used herein have the same meaning as commonly understood by one of ordinary skill in the art to which this invention belongs. The materials, methods, and examples provided herein are illustrative only and not intended to be limiting.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Implementation of the method and/or system of embodiments of the invention can involve performing or completing selected tasks manually, automatically, or a combination thereof.

Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a prior art illustration of the concept of a Voronoi diagram used for determining the domain of influences of twenty shops in a two-dimensional city. Each shop is represented by a point, and its domain of influence is represented by a cell which is a polygon;

FIG. 2 shows the boundaries of the cells of FIG. 1;

FIG. 3A shows an example of a Voronoi diagram of sites which are not points;

FIG. 3B is a simplified flow chart that illustrates a method of generating a Voronoi diagram such as that shown in FIG. 1, by subdividing a region, according to a first embodiment of the present invention;

FIG. 3C illustrates in greater detail the overall method of FIG. 3B;

FIG. 3D is a simplified flow chart illustrating the computing of endpoints for the method of FIG. 3C;

FIG. 3E is a simplified flow chart illustrating a routine for storing data generated by the method of FIG. 3B or 3C or 3D;

FIG. 3F illustrates a method of generating the Delauney graph using the information stored in accordance with the method of FIG. 3E;

FIG. 4 shows an example of several 3-dimensional Voronoi cells of point sites, together with some of the sites, bounded within a large overall box;

FIG. 5 shows a more complicated 3-dimensional Voronoi cell;

FIG. 6 shows the same cell of FIG. 5 but from a different perspective;

FIG. 7 shows an example of a 2-dimensional simplex (a triangle);

FIG. 8 shows an example of a 3-dimensional simplex (a pyramid);

FIG. 9 shows an illustration of the method of FIG. 3B for computing the Voronoi cells in the 2-dimensional case;

FIG. 10 shows an illustration of the method of FIG. 3B for computing endpoints;

FIG. 11 shows a small diameter partition of a subface of a 3D simplex and its sub-faces, for the method of FIG. 3B for computing the Voronoi cells in the 3-dimensional case;

FIG. 12 shows an example of a boundary point partition of type 1 of a subface of a 3D simplex and its sub-faces for the method of FIG. 3B in the 3-dimensional case;

FIG. 13 shows an example of a boundary point partition of type 2 of a subface of a 3D simplex and its sub-faces for the method of FIG. 3B in the 3-dimensional case;

FIG. 14 shows an example of a boundary point partition of type 3 of a subface of a 3D simplex and its sub-faces for the method of FIG. 3B in the 3-dimensional case;

FIG. 15 shows an example of an interior point partition of type 0 of a subface of a 3D simplex and its sub-faces for the method of FIG. 3B in the 3-dimensional case;

FIG. 16 shows an example of an interior point partition of type 1 of a subface of a 3D simplex and its sub-faces for the method of FIG. 3B in the 3-dimensional case;

FIG. 17 shows an example of an interior point partition of type 2 of a subface of a 3D simplex and its sub-faces for the method of FIG. 3B in the 3-dimensional case;

FIG. 18 shows an example of an interior point partition of type 3 of a subface of a 3D simplex and its sub-faces for the method of FIG. 3B in the 3-dimensional case; and

FIG. 19 shows an example of a 2-dimensional Delaunay graph (Delaunay tessellation) together with its associated Voronoi diagram.

### DESCRIPTION OF THE PREFERRED EMBODIMENTS

The present embodiments comprise a method for computing with improved efficiency and storing 2-dimensional and 3-dimensional Euclidean Voronoi diagrams, and applications therefor. It allows the computation of each cell independently of other cells, and hence supports parallel implementation. The present embodiments meet the challenges of degenerate cases, and allow the computation of sites consisting of many points. The present embodiments further permit retrieval, in any dimension, of the combinatorial information relating to the diagram, such as the vertices, edges, faces, the neighbors of a given vertex, and so on, and storing such information in a simple and convenient manner. In particular, the present embodiments allow for the computation of a related structure called the Delaunay graph (or the Delaunay tessellation or the Delaunay triangulation) in a more efficient way. The present embodiments further provide a more efficient method for the exact computation of endpoints.

The method disclosed in above mentioned U.S. patent application Ser. No. 12/461,216 to the present inventor, allows the approximate computation of general Voronoi diagrams (general distance functions, any dimension, etc.). The present embodiments provide an improvement thereon in the special but important case of the Euclidean distance and dimensions 2 and 3. The present embodiments further allow for retrieval and storage in a convenient way of the combinatorial information relating to the diagram in any dimension. The calculation of the present embodiment may also be implemented in a manner which is orders of magnitude faster as compared with the previous method and may provide more precise results. The storage is also more efficient.

The following is an illustration of possible applications which can be provided using the present embodiments in particular, and which relate to Voronoi diagrams in general.

There are several properties of the structure referred to as the Voronoi diagram which make it useful. Some of these properties are:
1. A Voronoi diagram induces a partition of a given space into cells, and it is easier to understand or analyze the cells, perform operations on them, etc, rather than try to apply an analysis on the whole space in one go. Furthermore, in many cases the partition follows naturally from the given setting.
2. Sometimes useful information about the whole space or parts of the space can be obtained from certain other parts of the space, e.g., Voronoi generators or the boundaries of the Voronoi cells.
3. By the very basic definition of the Voronoi diagram, its cells are defined by an optimal property. Specifically, the cell of the site (generator) Pₖ is the set of all the points in the space whose distance Pₖ is not greater than their distance to the other sites. Many applications are designed for achieving an optimal solution to a given problem and use the above optimal property of the cells.
4. A Voronoi diagram is a geometric structure which is related to other geometric structures which are useful in themselves, such as the Delaunay graph (the Delaunay tessellation) or the convex hull. The relationship may be that the other structures are more easily computed from the Voronoi diagram, or more generally that the Voronoi diagram enables computing of these other structures.
5. Voronoi diagrams appear naturally in many places in science and technology.

The following (far from being exhaustive) list of applications of Voronoi diagrams follows naturally from the properties discussed above.
1. Mesh generation and re-meshing, or rendering: the mesh is based on a triangulation, and the triangulation can be created directly by Voronoi diagrams or indirectly using Delaunay triangulation which is easily created by use of Voronoi diagrams.
2. Curve and surface generation/reconstruction, including solid modeling: again, based on triangulation, which approximates the surface. The triangulation may be created directly by using Voronoi diagrams or indirectly using Delaunay triangulation which is easily created from the Voronoi diagrams.
3. Robot motion in an environment with obstacles, collision detection: the goal of the robot is to move in a safe way, i.e., to avoid colliding with the obstacles. One generates the Voronoi diagram of the obstacles (as generators), and the robot moves on the boundaries of the cells. The boundaries are those places in the space which are as far as possible from the obstacles. This is also good for any machine or part thereof which is not necessarily a robot, say a mechanical arm, but which moves in an environment with obstacle, and subsequent references to robots herein are intended to refer to such machines or machine parts.
4. Motion of vehicles and/or accident prevention: The same principle applies as with the robot motion. The Voronoi diagram is computed and recomputed where the other vehicles are moving generators. The cells allow each vehicle to find a safest path. So the Voronoi generators are the vehicles and the other obstacles in the environment. The solution is good for any kind of vehicles and moving vessels, including land vehicles, ships, and other seagoing vessels including submarines, aircraft, satellites and so on, and the term vehicle used herein is to be understood accordingly.
5. Clustering and data processing: the method is used for storing and manipulating the data in an efficient and convenient way. A data record may be provided as a point in a space, with several components (e.g., representing the longitude and latitude of a point, the age, salary and id number of a worker and so on), and one divides the space using the Voronoi cells of certain points. Now one can efficiently and conveniently carry out operations on the data, for example because it is in a more simple and concise form. Operations that become easier include compression, searching, further subdividing and so on.
6. Proximity operations, nearest neighbor searches, data searches including searching in data bases, search engines, searching in files and so on. As in the previous application one partitions the space into the Voronoi cells of certain generators. Then, starting with an arbitrary initial point in the space, in order to find the generator which is closest or “resembles” this point, one only needs to determine the Voronoi cell in which the initial point is located.
7. Image processing: again, in order to analyze the image, a common way is via partitioning the image into small parts and working with these parts. The partitioning may be carried out directly using a Voronoi diagram, or indirectly using the Delaunay tessellation.
8. Simulations, analyzing, modeling and prediction of phenomena which are related to Geographic Information System (GIS): these are dynamic phenomena which consist of a large amount of data which often changes rapidly. Again, one partitions the space using the Voronoi cells of certain generators (depending on the phenomenon) or the Delaunay tessellations, and the diagram/tessellation is updated according to the changes related to the phenomenon. One obtains a convenient data structure which allows one to do efficient and convenient operations on it. In particular, this may help in weather prediction; navigation; prediction of spreading of diseases, contamination and fires; helping designing better vehicles by better understanding the water or air flows around them and the like.
9. Numerical simulations including finite element methods: The procedure is as with 8 above, but may be applied to many other phenomenon including simulations of astronomical phenomena, simulations of the behaviour of particles in a solution, motion/flow of vehicles in a highway or a crowd in a building, and so on.
10. Tool for solving facility location: for instance, where to optimally locate a new cellular antenna, a new restaurant or a new school. The Voronoi diagram is created using the antennas, restaurants, etc. as the generators.
11. Molecular biology: analyzing and modeling proteins and other biological structures. Here the Voronoi generators are certain molecules or atoms. Additionally, the Delaunay tessellation and other geometrical structures constructed from Voronoi diagrams (such as alpha and beta shapes) may be used. The application may help in understanding biological phenomena and designing drugs.
12. Material engineering: designing new materials or compounds. Analyzing and understanding existing materials is carried out by partitioning the material into the Voronoi cells, where the generators may be certain atoms, molecules or even defects in the material and so on.
13. Designing and testing integrated circuits: Here one may use Voronoi diagrams for measuring and modeling what is called the critical area of an integrated circuit. The Voronoi diagram partitions the integrated circuit into Voronoi cells within which defects that occur cause electrical faults between the same two shape edges in the design. For computing the critical area for a particular fault mechanism, one constructs the Voronoi diagram for that particular fault mechanism.
14. Shortest paths: In one application one can use Voronoi diagrams for finding the shortest path between two points/shapes in a graph or an environment with obstacles. The shapes represent the generators and the boundaries of the Voronoi cells, which are used for computing the path. Examples include designing a better integrated circuit by saving the amount of wiring needed, or designing a better route for a bus or a mechanical arm.
15. A tool for constructing useful geometric structures: For example the Voronoi diagram may be used to construct the Delaunay graph, otherwise known as the Delaunay tessellation, or the convex hull, or the medial axis, or a special case of Voronoi diagrams called centroidal Voronoi diagrams in which the sites are in the center of mass of their corresponding cells. These geometric structures in turn have many applications; for instance, Delaunay graphs and centroidal Voronoi diagrams can be used for image and signal processing, mesh generation, clustering, numerical simulations and various others applications.
16. Pattern recognition, and computer graphics: The partition of the image into Voronoi cells of certain generators helps in analyzing the image and finding patterns or key features in the image. Another possibility is to construct the medial axis or Delaunay tessellation associated with a certain Voronoi diagram, and use the construction for pattern recognition. Examples include character recognition (OCR), and facial recognition. Yet another possibility is to create an image having good properties using Voronoi diagrams.
17. Analyzing and designing communication networks: here the sites are the static or dynamic communication devices, for example antennas, cell phones, computers, etc.
18. Signal processing and creating, coding: here the sites can be an element in a video signal, a digital code in a noisy environment and so on.
19. A tool for analyzing the behaviour and growth of crystals: the sites are the points from where the crystals start to grow.
20. Location based services: these are services based on geographic data and may be related to dynamic phenomena. The sites may be people, populations, cell phones, antennas, vehicles, shopping centres and so on. The service may be population monitoring, analyzing the behaviour of customers, or consumers in general, analyzing traffic data, offering deals to costumers which are in the vicinity of a business, etc.

In the description below the following notation is used: one starts with a region X, called the world, and a collection of sets P₁, P₂, . . . , Pₙ called the sites or the generators. The dimension of the world X is denoted by m, usually 2 or 3, but in principle it can be higher. The elements in the world X are called points or vectors. A vector x in X has m components and is denoted by x=(x_{—}1, . . . , x_m) or x=(x₁, . . . xₘ). The length or norm of a vector x=(x₁, . . . , xₘ) is |x|=(|x₁|̂2+ . . . +|xₘ−yₘ|̂2)̂0.5, i.e., the square root of the sum of the squares of its elements. The distance between any two points x=(x₁, . . . , xₘ) and y=(y₁, . . . , yₘ) in the world is measured using a distance function d which is the Euclidean distance d(x,y)=((|x₁−y₁|̂2+ . . . +|xₘ−yₘ|̂2)̂0.5, i.e., the length of the vector x−y=(x₁−y₁, . . . xₘ−yₘ). The distance between the points x and y is also denoted by |x−y|. The distance between a point x and a set A is d(x,A)=min{d(x,a): a in A}. The inner (scalar) product between the vectors x=(x₁, . . . , xₘ) and y=(y₁, . . . , yₘ) is <x,y>=x₁·y₁+ . . . +xₘ·yₘ. A vector x=(x₁, . . . , xₘ) is called nonnegative if the inequality xᵢ≧0 holds for each i=1, . . . , m.

The dominance region (or domain of influence) of the set P with respect to the set A is the set of all the points in the world whose distance to the set P is not greater than their distance to the set A. It is denoted by dom(P,A).

Given the sites P₁, . . . , Pₙ, the Voronoi cell of the site Pₖ is simply the set of all the points in the world whose distance to the site Pₖ is not greater than their distance to the union of the other sites Pⱼ. In other words, it is the set dom(Pₖ, Aₖ) where Aₖ is the union of all Pⱼ, j≠k. Given a direction, represented by a unit vector θ (i.e., |θ|=1), and given some point p in some site Pₖ, the point p+T(θ,p)θ is the point of intersection of the ray emanating from p in direction θ and the boundary of the cell of p. It is called the endpoint in direction of θ. The number T(θ,p) is the distance from p to this endpoint.

A hyperplane is a line in dimension m=2, a plane in dimension m=3 and so on.

FIG. 4 shows an example of several 3-dimensional Voronoi cells of point sites, together with some of the sites, bounded within a large overall box.

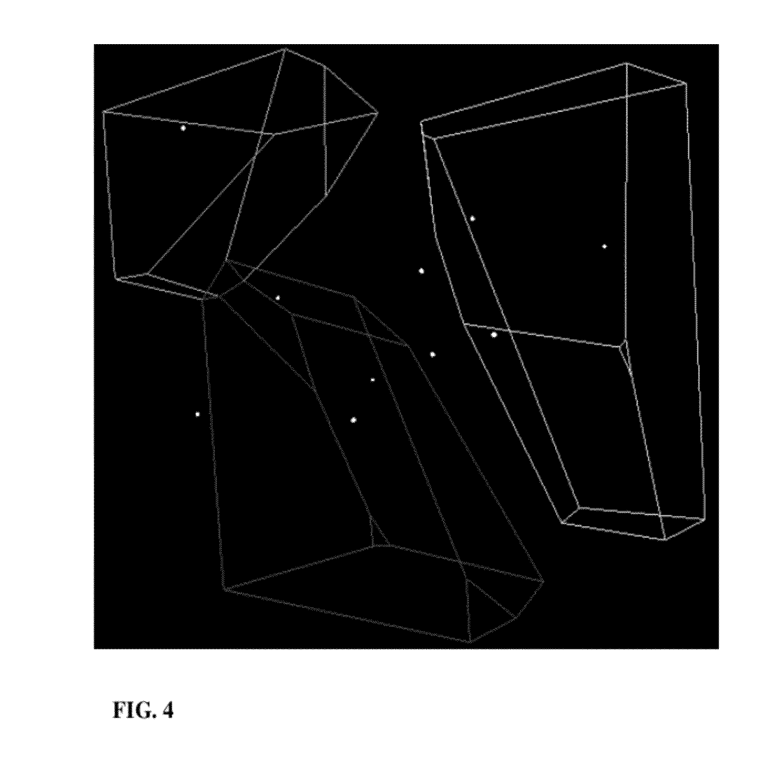

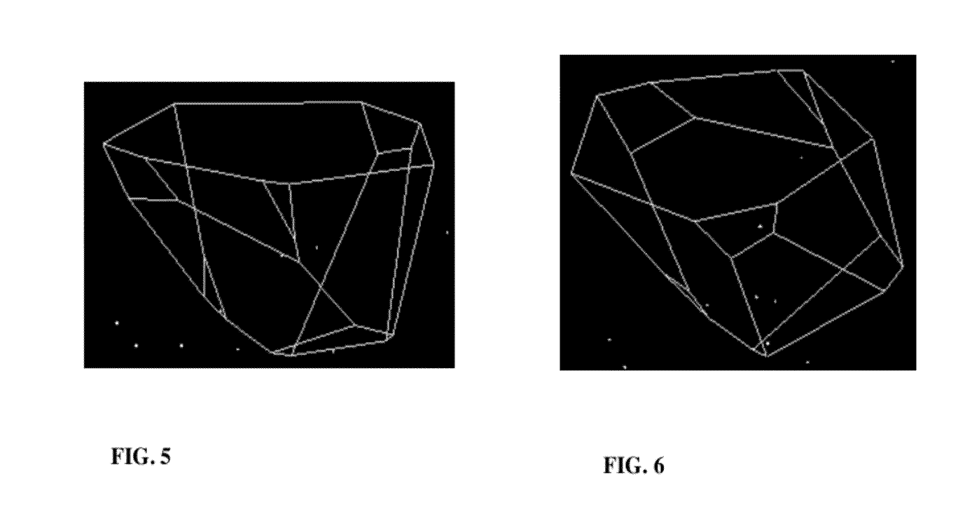

FIG. 5 shows a more complicated 3-dimensional Voronoi cell.

FIG. 6 shows the same cell of FIG. 5 but from a different perspective.

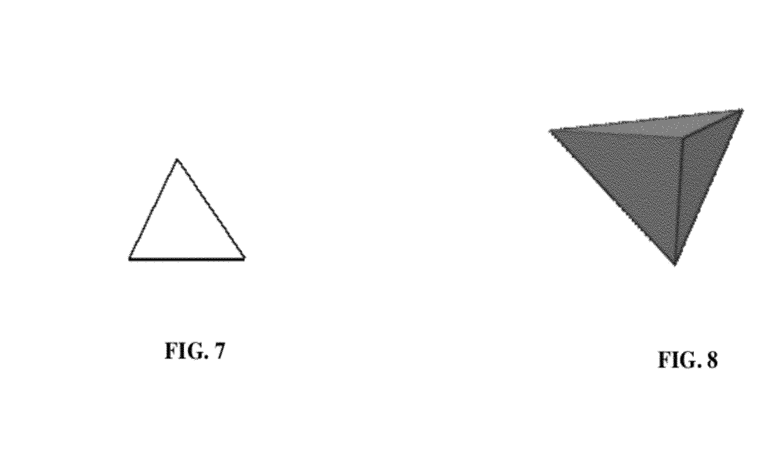

A simplex is a triangle in dimension m=2, as illustrated in FIG. 7 and is a pyramid in dimension m=3 as shown in FIG. 8. A bisecting plane (or hyperplane) corresponding to some point u is a plane L which is in the middle between u and one of its neighbor sites a (the plane L passes via the middle of the interval [u,a] and is vertical to it). If u is on the boundary of the world X, i.e., on one of the world faces, the plane on which this face is located will also be called a bisecting plane of u. A bisector is a bisecting (hyper)plane.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

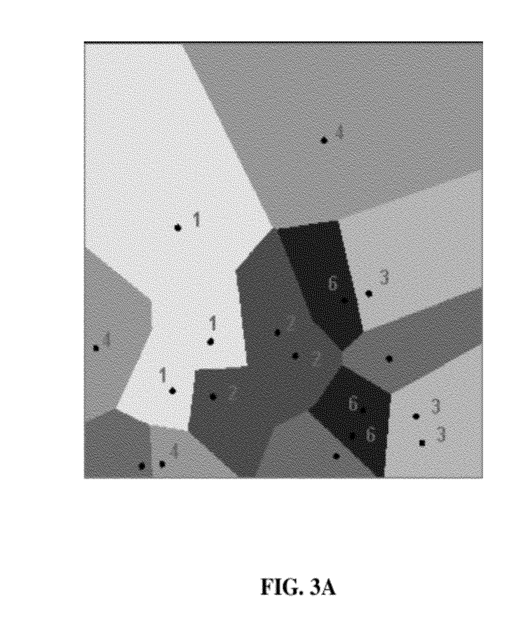

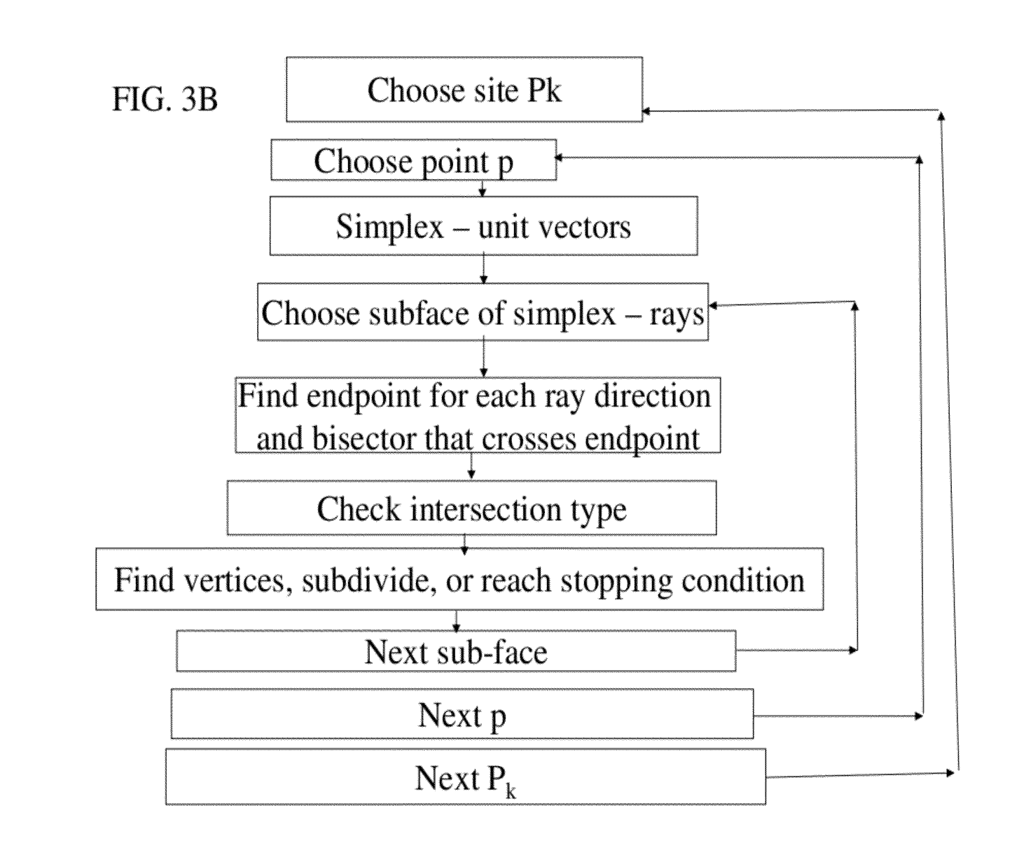

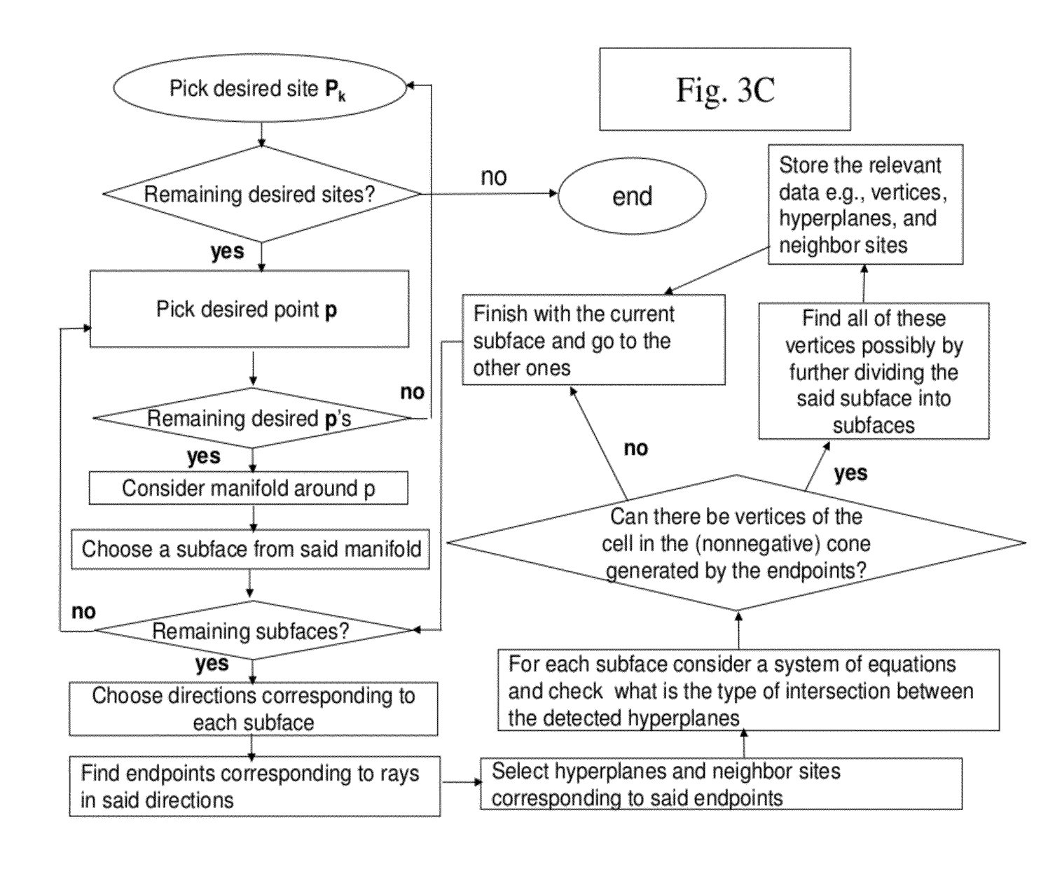

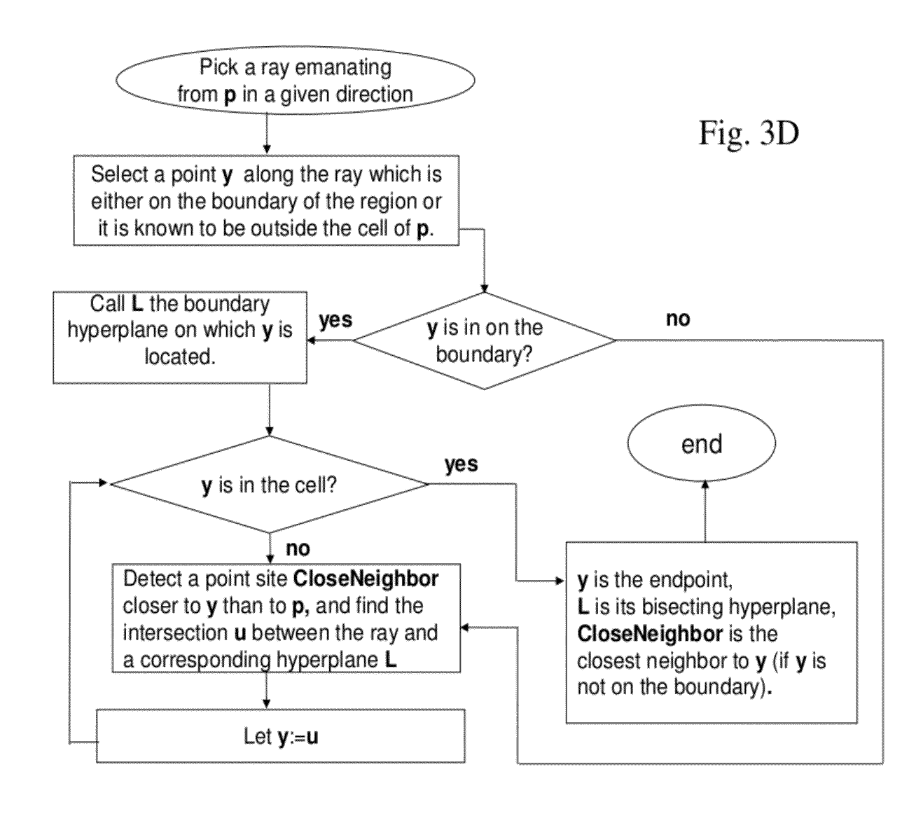

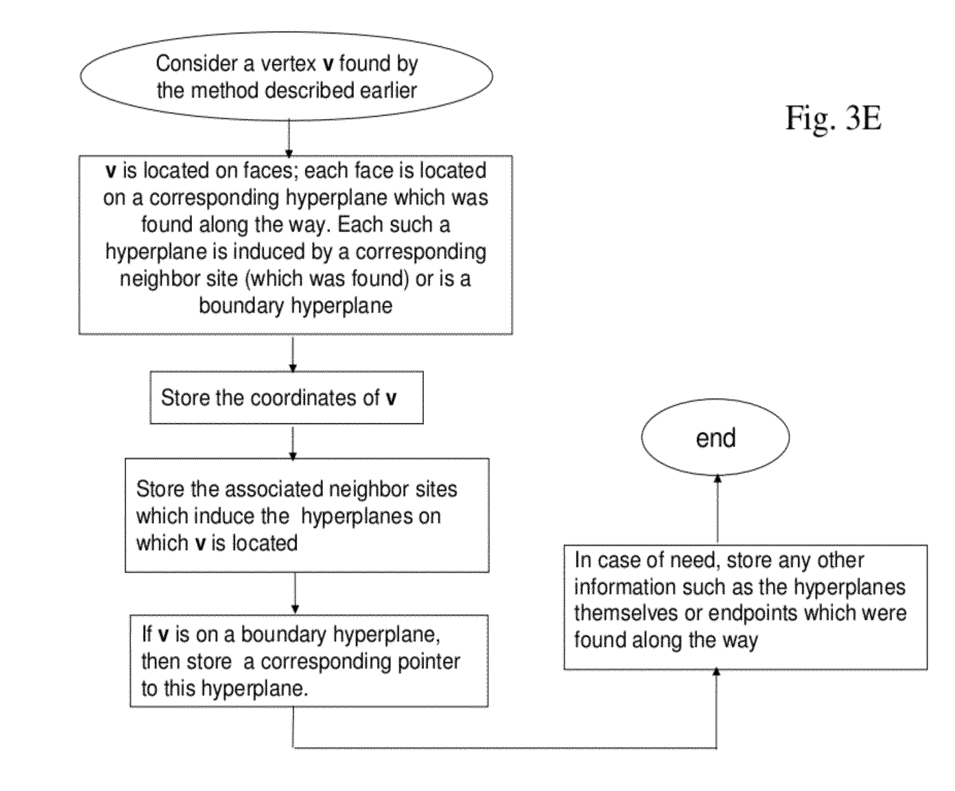

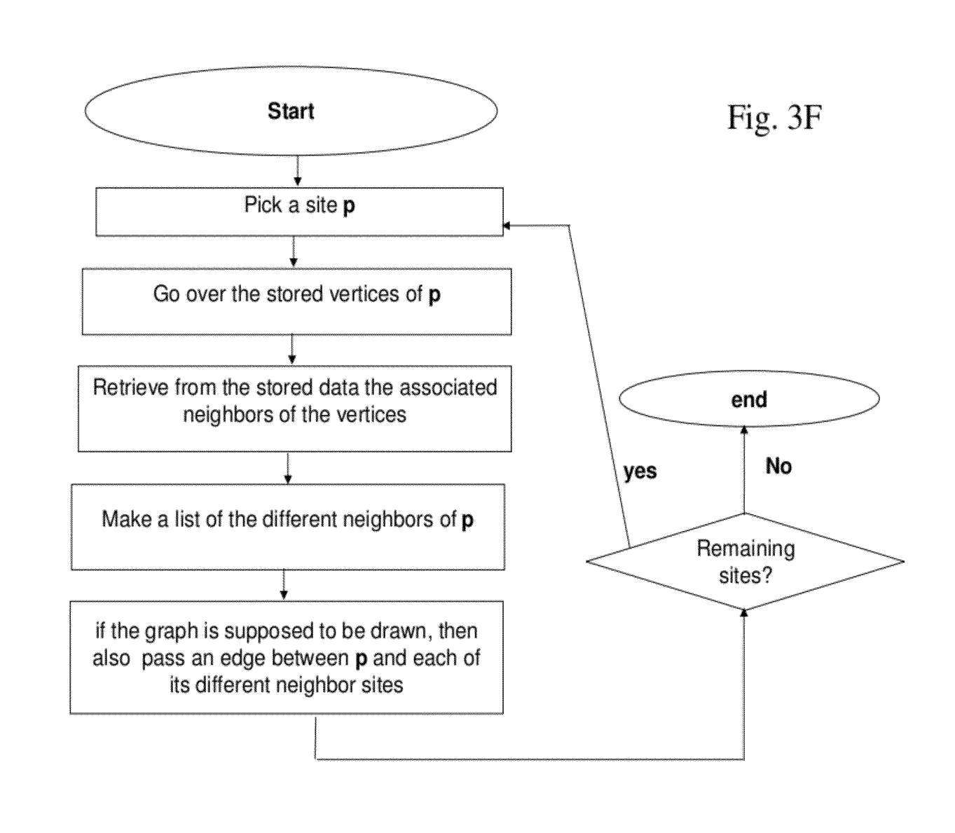

Reference is now made to FIG. 3B which illustrates a computerized method of decomposing a given region X into cells. The decomposition is induced by a set of sites P₁, . . . , Pₙ, and a distance function d, and involves finding for each desired site Pₖ a cell. The cell that is found is the cell that comprises a set of all the points in X satisfying a distance inequality condition, based on a distance function. The distance condition is that the distance of a respective point to the site Pₖ is not greater than the distance of the respective point to the union of the other sites, and such a decomposition is a way of defining the generation of the Voronoi diagram.

The method is suitable for carrying out on an electronic processor and may comprise:

a) selecting a desired site Pₖ and a desired point p in the site;

b) selecting a plurality of subfaces corresponding to a manifold around the point p;

c) for each desired subface selecting multiple directions;

d) for each direction providing a ray, and selecting a point on the ray as an endpoint, then selecting hyperplanes corresponding to the endpoints;

e) for each desired subface determining a type of intersection between the detected hyperplanes;

f) determining whether there can be vertices of the cell in a non-negative cone generated by the endpoints, and finding these vertices. If there might remain further vertices that have not been found then there is carried out a step of further dividing the subface into additional subfaces for separate determination but stopping if a given stop condition is reached;

g) storing the vertices, hyperplanes, neighbor sites, and possibly endpoints, in a machine readable format, these being data relating to a vertex or hyperplane;

h) repeating a)-g) for each desired site Pₖ and each desired point p in the selected site;

i) defining at least one vertex or hyperplane from the endpoints, thereby decomposing the region X into subregions; and

j) outputting the decomposed region X in a machine readable format.

The Voronoi diagram generated by the above method may applied to uses including any of the following: controlling or managing a communications network, controlling or managing a robot, modeling, testing controlling or simulating a three-dimensional network, testing or modeling a material, data searching, searching for data on a network or database, image processing, mesh generation and re-meshing, curve and surface generation, curve and surface reconstruction, solid modeling, collision detection, controlling motion of vehicles, navigation, accident prevention, data clustering and data processing, proximity operations, nearest neighbor search, numerical simulations, weather prediction, analyzing or modeling proteins, analyzing or modeling crystal growth, analyzing or processing digital or analog signals, analyzing or modeling biological structures, designing drugs, finding shortest paths, pattern recognition, rendering, data compression, providing overall control of a different methods for image processing, providing overall control of different methods for data categorization, providing overall control of different methods for data clustering, designing and testing of electronic circuits, management of geographic information systems, locating a resource according to the solution of an efficient location problem, face recognition, analyzing the behavior of populations, analyzing or modeling data related to astronomy, analyzing or modeling data related to geography, detecting or analyzing geometric structures, detecting or analyzing space structures, location based services, analyzing atmospheric data, analyzing oceanographic data, analyzing traffic, detecting or analyzing the distribution of matter in a region, detecting or analyzing the distribution of populations in a region, detecting or analyzing the distribution of energy in a region, and in providing an artistic tool.

In stage d) it is possible additionally to select hyperplanes that correspond to neighbor sites or to the boundary of the region X.

The determination of a type of intersection may comprise a given system of equations under the conditions set by the vertex being examined, as will be discussed in greater detail below.

Determining of vertices in the cone may comprise further examining the system of equations.

The manifold may be a simplex manifold.

In stage f) the stopping condition may be used when finding vertices in a cone corresponding to a selected initial subface as well as in additional cones corresponding to subfaces following subdividing.

A subface to be selected may be determined by corners or by unit vectors corresponding to the corners.

The method is shown in greater detail in FIG. 3C.

The system of equations may be of the form

Bλ=H,

wherein:
m is the dimension of said region X;
θᵢi=1, . . . , m are direction unit vectors;
p+Tᵢ is the endpoint in direction θᵢ;
Tᵢ=T(θᵢ,p)θᵢ is the vector whose direction is θᵢ and whose length is the distance between point p and endpoint p+T_i;
L_i is the hyperplane corresponding to the endpoint p+Tᵢ;
Nᵢ is a normal to the hyperplane Lᵢ;
λ=(λ₁, . . . , λₘ) is a vector of unknowns;
B is an m by m matrix with Bᵢⱼ=<Nᵢ,Tⱼ>, i,j=1, 2, . . . , m; and
H=(H₁, . . . , Hₘ) is the vector with Hᵢ=<Nᵢ,Tᵢ>, i=1, 2, . . . , m.

The method may further include:

computing respective vertices by solving the system of equations to obtain a solution λ=(λ₁, . . . , λₘ), and

checking if a corresponding vector u=p+λ₁T₁+ . . . λₘTₘ, comprising the vectors T₁, . . . , Tₘ and the point p, is in the cone and in the cell, m being the dimension of the region X, which may typically be 2 or 3.

The region X may be of dimension two. In such a case the method may involve dividing the given subface into additional subfaces. Dividing may involve choosing an intermediate vector between respective corners of the subface to create two new subfaces, where each new subface comprises the intermediate point and one of the corners, or vectors in a direction of the corners.

The region X may be of dimension two and deciding whether there are vertices of the cell in the cone generated by the endpoints may comprise checking one or more of:

a number of the hyperplanes,

whether there exist nonnegative solutions to the system of equations,

whether the determinant of matrix B vanishes or not,

whether there are infinitely many solutions, a unique solution or no solution at all to the system of equations.

Alternatively, the region X may be of dimension three. Dividing the given subface into additional subfaces may then involve dividing the subface into a partition of additional subfaces, where the partition is chosen from the following list of possible partitions:

no partition at all,

a “small diameter partition”,

“an interior point partition of type 0”,

“an interior point partition of type 1”,

“an interior point partition of type 2”,

“an interior point partition of type 3”,

“a boundary point partition of type 1”,

“a boundary point partition of type 2”, and

“a boundary point partition of type 3.”

In the case of dimension three the stage of deciding whether there are vertices of the cell within the cone generated by the endpoints may comprises one or more of the following:

checking the number of different hyperplanes,

checking whether there exist nonnegative solutions to the system of equations,

checking whether the matrix B is of rank 1, or rank 2, or rank 3, or of rank smaller than the rank of another matrix B_{H}, or

checking whether there are infinitely many solutions, unique solution or no solution at all to the system of equations.

The computations would typically be carried out to a predetermined level of error parameters.

The method may reuse cell calculations of earlier stages for saving calculations in later stages.

Reference is now made to FIG. 3D, which is a simplified schematic flow chart illustrating calculation of an endpoint. Computation of an endpoint in a given direction θ may comprise selecting a point y along the corresponding ray in direction θ, and moving and testing y recursively, until a stopping condition is satisfied.

The stopping condition may, for example, comprise either using a result of a distance inequality, or testing whether a parameter is smaller than a given error parameter. Recursive testing may comprise selecting a point y along the ray emanating from p.

y may be on the boundary of region X or outside the cell of p. Now, if y is on the boundary, then one may define L as a corresponding hyperplane on which y is located and then check whether y is in the cell.

If y is in the cell, then one may select y as an endpoint and define L as the corresponding bisecting hyperplane on which y is located.

If y is neither within the cell of p nor on a boundary of region X, then one may find a corresponding point closer to y than to p, and determine an intersection u between the ray and a corresponding hyperplane L. Then one may set y:=u, recursively testing until y is in the cell of p at which point one sets y as the endpoint. The corresponding point may be a closest neighbor site or a point in the closest neighbor site, and L may be the corresponding bisecting hyperplane.

Reference is now made to FIG. 3E, which illustrates a method of storing information for the Vorronoi diagram. The method may involve retrieving combinatorial information related to the cells to a storage device, such as an electronic or magnetic storage device, the information including any combination of vertices, sides, faces (of any dimension), neighbors of a give vertex, the vertices of a given face in a desired order, and a Delaunay graph. The method may involve storing, in the storage device, for each desired site Pₖ and each desired point p, data related to any desired vertex u belonging to the cell of said p, the data comprising the coordinates of the vertex u, associated neighbor sites, associated hyperplanes and endpoints; and using the information to obtain information about the cells.

The method may involve applying the combinatorial information inter alia in any of the following applications: controlling or managing a communications network, controlling or managing a robot, modeling, testing, controlling or simulating a three-dimensional network, testing or modeling a material, data searching, searching for data on a network or database, image processing, mesh generation and re-meshing, curve and surface generation, curve and surface reconstruction, solid modeling, collision detection, controlling motion of vehicles, navigation, accident prevention, data clustering and data processing, proximity operations, nearest neighbor search, numerical simulations, weather prediction, analyzing or modeling proteins, analyzing or modeling crystal growth, analyzing or processing digital or analog signals, analyzing or modeling biological structures, designing drugs, finding shortest paths, pattern recognition, rendering, data compression, providing overall control of a plurality of methods for image processing, providing overall control of a plurality of methods for data categorization, providing overall control for a plurality of methods for data clustering, designing and testing of electronic circuits, management of geographic information systems, computing geometric objects, locating a resource according to the solution of an efficient location problem, face recognition, analyzing the behavior of populations, analyzing or modeling data related to astronomy, analyzing or modeling data related to geography, detecting or analyzing geometric structures, detecting or analyzing space structures, location based services, analyzing atmospheric data, analyzing oceanographic data, detecting or analyzing the distribution of matter in a region, detecting or analyzing the distribution of populations in a region, analyzing traffic, detecting or analyzing the distribution of energy in a region, and simply providing an artistic tool.

The method may comprise finding neighbor vertices of said vertex u with a given combinatorial representation by writing all vertices v for which m−1 of their hyperplanes in their combinatorial representation coincide with those of vertex u, m being the dimension of the region X.

The method may involve finding all the vertices on a given face corresponding to a given hyperplane L.

Finding may involve:

determining all vertices v with Lᵢ in respective combinatorial representation;

finding all (m−2)-dimensional faces of said Lᵢ by selecting an L_j, j≠i belonging to a vertex on Lᵢ, finding all vertices with Lᵢ and Lⱼ in their combinatorial representation, and

repeating the process with other Lⱼ's; where m is the dimension of the region X, as before.

In an embodiment, the method may generate a convex hull from a collection of sites by selecting sites for which one of the faces of their cell is contained in the boundary of the overall region X.

The method may involve finding, from the stored data, different neighbors of a site p; computing therefrom a Delaunay tessellation; and passing an edge between a site p and some of its different neighbor sites.

The Delaunay tessellation may be applied to any of the previously discussed applications.

In the following, a schematic description of the first embodiment is presented.

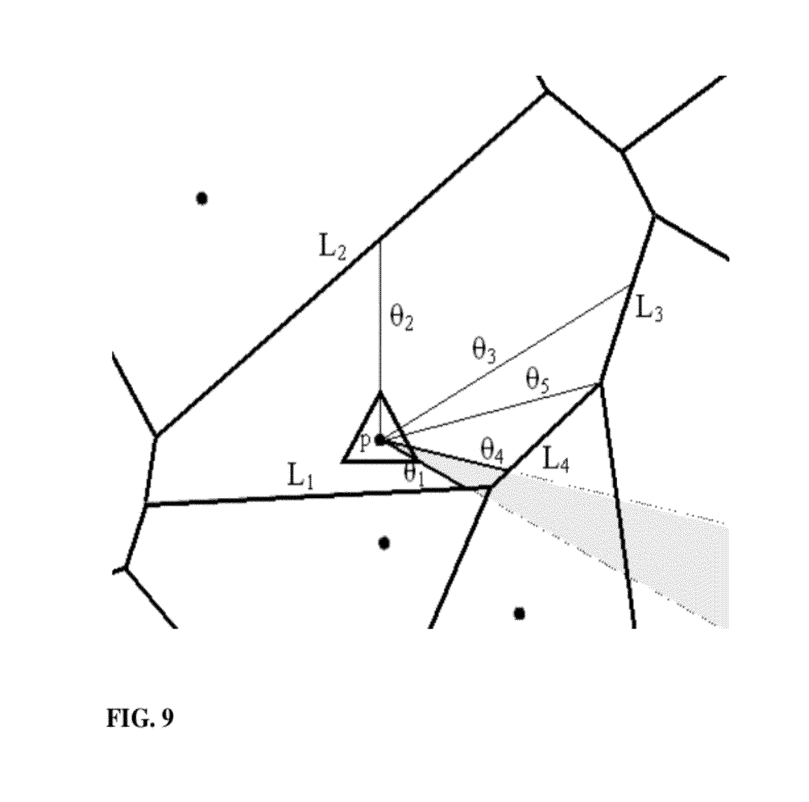

It is assumed that the distance used for the condition is the Euclidean distance, that there are finitely many sites, and that each of the sites consists of finitely many points. This allows one to treat sites with infinitely many points, such as balls or sites with strange shape, since each such site can be approximated to any required precision by a finite subset of points. The key ideas behind the method may be described in any dimension, and full details will be given later for dimension 2 and 3. See FIG. 9 below for an illustration in dimension 2.

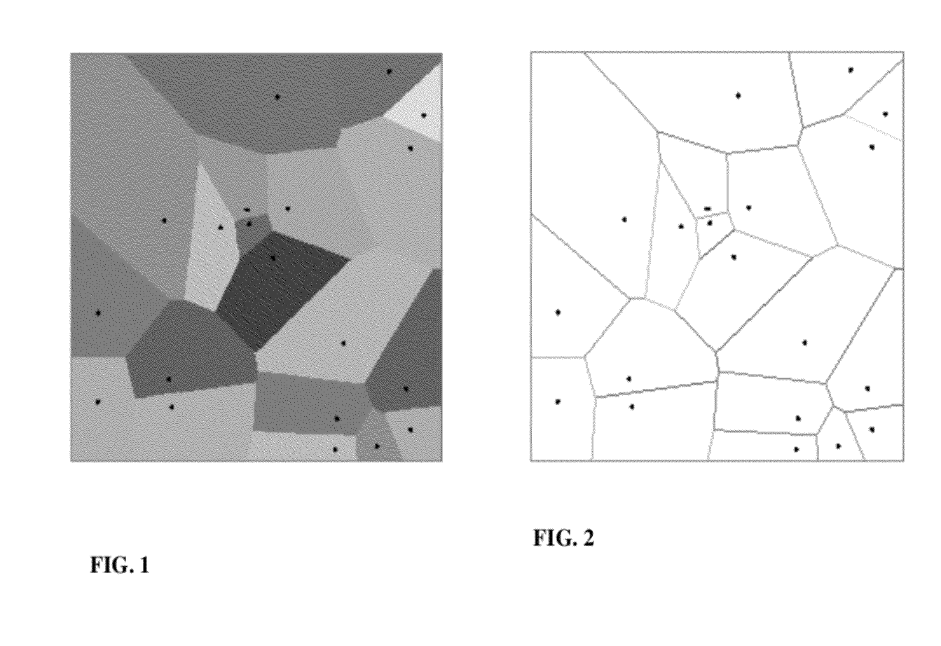

The method is based on the fact that under the above assumptions the cell of a given point p (belonging to some site Pₖ) is a convex polygon whose boundary consists of vertices and faces. See FIGS. 1 and 2. Despite the fact that the cell of a given site Pₖ may not be convex (see FIG. 3), it can be computed by computing the cells of each of its points p.

Referring again to FIG. 3B, the method may proceed as follows:
1. A site Pₖ and a point p in Pₖ are chosen. The goal is to compute the Voronoi cell of p, namely dom(p,Aₖ) where Aₖ is the union of all Pⱼ, j≠k.
2. Consider a simplex around p; The simplex is used in order to create the unit vectors and to obtain other information regarding the cell;
3. Choose a (sub)face of the simplex and create the unit vectors θ₁, . . . , θₘ in the direction of its corners. Then shoot rays in these directions;
4. By taking into account the fact that the bisectors are (hyper)planes, for each direction θ₁, . . . , θₘ find its corresponding endpoint p+T(θᵢ,p)θᵢ and a corresponding bisector Lᵢ on which this endpoint is located;
5. By examining a certain system of equations, check what is the type of intersection between the detected hyperplanes;
6. Use the information obtained from the system of equations to decide whether there are vertices of the Voronoi cell in the (nonnegative) cone generated by the endpoints, and either find all of them (together with the hyperplanes on which they are located), possibly by further dividing the simplex (sub)face to subfaces, or reach a stopping condition for the current (sub)face and go to other (sub)faces.
7. The process continues until the treatment of all of the subfaces is finished. In other words, at each stage one finds all the possible vertices located in the part of the space “at which one looks”, and the process ends when one finishes “covering” all the space.
8. The above is repeated until dom(p,Aₖ) is computed for each desired point p in Pₖ and each desired site Pₖ.

The system of equations mentioned above is

Bλ=H, (*)

where:

the vector of unknowns is λ=(λ₁, . . . , λₘ);

B is the m by m matrix whose components are Bᵢⱼ=<Nᵢ,Tⱼ>;

the components of the vector H=(H₁, . . . , Hₘ) are defined by Hᵢ=<Nᵢ,Tᵢ>, i,j=1, 2, . . . , m, where Tᵢ=T(θᵢ,p)θᵢ denotes the vector in the direction of θ whose length is the distance from p to the endpoint, and Nᵢ is a normal to the hyperplane

Lᵢ={x: <Nᵢ,x>=cᵢ=<Nᵢ,p+Tᵢ>} on which the endpoint p+Tᵢ is located.

Equation (*) has the following simple geometric meaning: the point

u=p+(λ₁T₁+ . . . +λₘTₘ)

is in the intersection of the hyperplanes L₁, . . . , Lₘ defined above if and only if λ solves this equation. If one wants to restrict oneself to the cone generated by the endpoints, then one considers only the nonnegative solutions of equation (*), i.e., λ_i≧0 for all i=1, . . . , m. If equation (*) has a unique nonnegative solution λ, then this means that the above vector u is a point in the cone which is a candidate to be a vertex of the cell, since it may be (but is not necessarily) in the intersection of the corresponding m different faces located on the hyperplanes L₁, . . . , Lₘ. If, in addition, u is found to be in the cell, then it is indeed a vertex of the cell.

A description for the case of dimension m=2 follows:

The method of FIG. 3B can be best understood in dimension m=2, and the details are given below. Things become more complicated for dimension m=3, mainly because of Stage 6 above. In order to find all the possible vertices in some part of the space “viewed from p”, one takes into account many cases which do not occur in dimension 2, as will be discussed in greater detail hereinbelow.

A pseudo-code for the case m=2 is given below. Reference is now made to FIG. 9 which is a schematic illustration of the two-dimensional case. In FIG. 9, the first subface is represented by {θ₁, θ₂}. The intersection of L₁ and L₂ is a point outside the cone generated by the rays in the directions of θ₁, θ₂. The next two subfaces are {74 ₁, θ₃}, {θ₂, θ₃}. The cone generated by the rays in the directions of θ₁, θ₄ is shown

In what follows the method and the pseudo-code will be explained in more detail.

First, one creates the 3 unit vectors θᵢ corresponding to a simplex (a triangle) around the point p. After choosing a simplex subface, one shoots the two rays, and finds the corresponding bisecting lines Lᵢ. One wants to use this information for finding all of the possible vertices in the cone generated by the rays. By using equation (*) one determines the type of intersection between the lines L₁,L₂. The intersection is either the empty set, a point, or a line. The value of the determinant det(B) is used for distinguishing between the cases.

If det(B)=0 and L₁=L₂ (corresponding to the case where there are infinitely many solutions, i.e., the intersection is a line), then, as it can be easily verified, there is no vertex of the cell in the interior of the cone. Possibly one of the endpoints p+Tᵢ is a vertex, but this vertex can be found with a different subface, and hence one can finish with the current subface and proceed to the other subfaces.

If det(B)=0 and L₁≠L₂ (corresponding to the case where there is no solution of any kind, including solutions which are not non-negative, i.e., the intersection is the empty set), then one does not have enough information to decide if the cone corresponding to the current simplex subface contains vertices of the cell, and hence one divides this subface into two (equal) subfaces and continues the process with each of these subfaces.

If det(B)≠0 (corresponding to the case where there exists a unique solution λ=λ₁,λ₂)), then two possibilities may occur. In the first, λ is not nonnegative, i.e., u=p+λ₁T₁+λ₂T₂ is not in the cone, and in this case one does not have enough information about possible vertices in the cone so one divides the current subface into subfaces and continues the process. Otherwise, λ is nonnegative, i.e., u is in the cone. If u is in the cell (something which can be checked, for instance, by distance comparisons), then it is a vertex and one stores the vertex together with any other relevant data such as the corresponding lines and so on as discussed in greater detail hereinbelow. After storing u one has finished with the current subface and can proceed to the other subfaces. Otherwise (i.e., u is outside the cell) u is not a vertex, and one has actually found a new line corresponding to the ray in the direction θ₃:=(u-p)/|u-p|. One divides the current subface using θ₃ and continues the process.

From the above description it seems that the method should be implemented in a recursive way. However, by using a simple data structure, herein referred to as FaceList, one can avoid the need to use a recursive implementation and instead can use loops. The reason that this is possible is because the treatment of each subface can be carried out independently of the other subfaces, including its “parent’” or “children”: no information is exchanged between the subfaces. As a result, one can maintain a list of subfaces, the FaceList—in which each subface is represented by a set of two unit vectors, which correspond to its corners, and run the process until the list is empty. The initial list contain the faces of the simplex, namely {φ₁, φ₂}, {φ₂, φ₃}, and {φ₁, φ₃}, where one can take φ₁=(0.5·√3,−0.5), φ₂=(0,1), φ₃=(−0.5·√3,−0.5).

In this connection it may be emphasized that the simplex is used, conceptually, for creating the unit vectors, but these unit vectors are only in the direction of the corners of a given subface, and they are not necessarily on the same line as the one on which the subface is located. Despite this, it is convenient to represent a subface by its associated unit vectors.

A pseudocode for the method in dimension 2:

Input: The sites.
Output: The Voronoi cells.
1. Create the simplex unit vectors and call them φᵢ, i=1, 2, 3;
2. For each desired site Pₖ do
3. For each desired point p in Pₖ do
4. Create the initial faces and enter them into FaceList;
5. Let fl be the index running on FaceList;
6. Let θᵢ=φᵢ, i=1,2 and fl={θ₁,θ₂}; [simply an initialization]
7. While FaceList is nonempty do
8. Denote Tᵢ=T(θᵢ,p)θᵢ and compute the endpoints p+Tᵢ, i=1,2;
9. Find a (closest) neighbor site gᵢ, i=1,2 (or a point in it if a site has more than one point) to p+Tᵢ;
10. Compute the bisecting line Lᵢ between p and gᵢ, i=1,2. If no gᵢ exists for some i, then p+Tᵢ, is on the boundary of the world. Call Lᵢ to the corresponding boundary line;
11. Consider the system of equations (*)
12. If det(B)=0 then [no solution or infinitely many]
13. If L₁=L₂ then [no vertices in this cone; we are done]
14. Remove {θ₁,θ₂} from FaceList;
15. Assign to fl the next element in FaceList;
16. Else [not enough information (no solution), so continue]
17. Define θ₃=(θ₁+θ₂)/|θ₁+θ₂|; [i.e., (θ₁+θ₂)/2 normalized]
18. Enter the subfaces {θ₁, θ₃}, {θ₂, θ₃} into FaceList;
19. Remove {θ₁,θ₂} from FaceList;
20. fl={θ₂, θ₃}; [just a new initialization]
21. Else [i.e., det(B)≠0, namely a unique solution X]
22. If λ is nonnegative then [we are in the nonnegative cone]
23. Let u=p+λ₁T₁+λ₂T₂;
24. If u is inside the cell of p then
25. Store u; [u is a vertex of the cell. We are done]
26. Remove {θ₁,θ₂} from FaceList;
27. Assign to fl the next element in FaceList;
28. Else [u is outside the cell. We continue]
29. Let θ₃=(u-p)/|u-p|;
30. Create the (at most) 2 subfaces {θ₁, θ₃}, {θ₂, θ₃} and enter them into FaceList;
31. Remove {θ₁,θ₂} from FaceList;
32. fl={θ₂, θ₃}; [just a new initialization]
33. Else [u is not in the cone. Not enough information]
34. Define θ₃=(θ₁+θ₂)/|θ₁+θ₂| [i.e., (θ₁+θ₂)/2 normalized]
35. Enter the subfaces {θ₁, θ₃}, {θ₂, θ₃} into FaceList;
36. Remove {θ₁,θ₂} from FaceList;
37. fl={θ₂, θ₃}; [just a new initialization]

### Finding the Endpoints Exactly

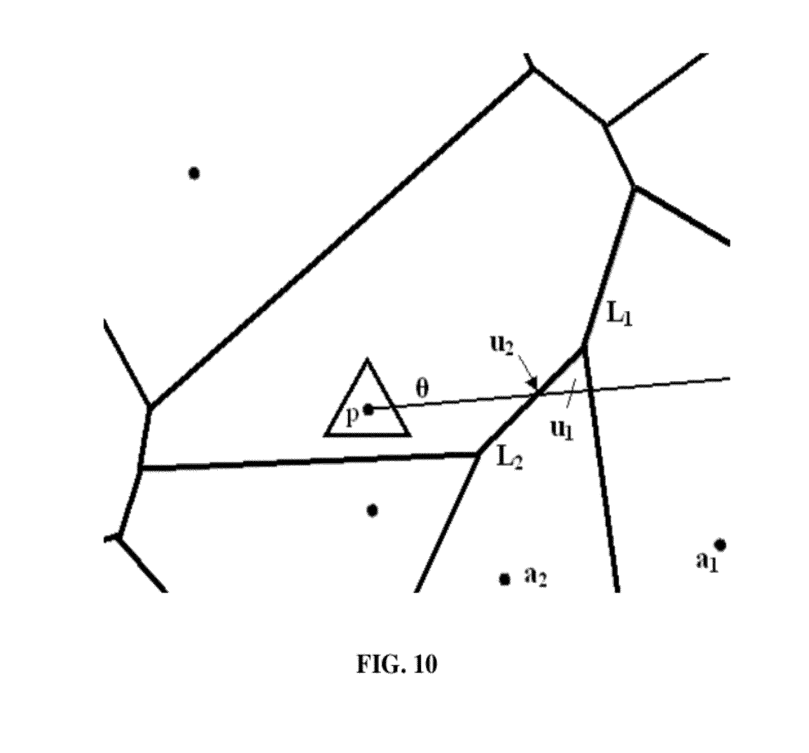

In order to apply the above method, one should be able to find the endpoint p+T(θ_i,p)θ_i. One possible method is to use the method disclosed in U.S. patent application Ser. No. 12/461,216, but the problem is that the endpoint found by this method is approximated: it is given up to some error parameter, and unless this parameter is very small, this may cause an accumulating error later when finding the sides and vertices, due to numerical errors in the expressions in equation (*). In what follows a further method will be described for finding precisely the endpoint in a given direction θ. Of course, when using floating point arithmetic errors appear, but they are much smaller than the ones described above. The method can be implemented in any dimension. Reference is made to FIG. 10 for an illustration in dimension 2. Specifically, FIG. 10 shows a schematic illustration of the method for finding the endpoint of a given ray. The dimension of the world is 2. The ray comes from far away. At the first displayed iteration CloseNeighbor is a₁. The intersection between the corresponding line L₁ and the ray is u=u₁. At the next stage CloseNeighbor is a₂ and u=u₂. The process ends since u₂ is in the cell of p, i.e., u₂ is the endpoint. More details about certain steps are mentioned in later sections.

method:Endpoint:
1. Shoot a ray in the direction of θ and stop it at a point y which is either in the region X but outside the cell of p, or it is the intersection of the ray with the boundary of the region. If y is choosen to be outside the cell then go to Step 4. Otherwise, let L be the boundary hyperplane on which y is located.
2. Check whether y is in the cell of p, e.g., by comparing d(y,p) to d(y,a) for any a in the other sites, possibly with enhancements. A possible way for accelerating the computation is, each time when it is found that d(y,p)≦d(y,a) for some a, then a can be removed from the list A of points in the other sites, since it will always be the case that also later (for later values of y along the ray) the inequality d(y,p)≦d(y,a) will hold.
3. If y is in the cell, then y is the endpoint and L is the bisecting hyperplane. The calculation along the ray is complete.
4. Otherwise, d(y,a)<d(y,p) for some a in some (different) site. Let CloseNeighbor:=a.
5. Find the point of intersection (call it u) between the given ray and the bisecting hyperplane L between p and CloseNeighbor. This intersection is always nonempty. The hyperplane is easily found because it is vertical to the vector p-CloseNeighbor and passes via (p+CloseNeighbor)/2.
6. Let y:=u. Go to Step 2.

A more detailed description of the method of FIG. 3B is now provided for the case of dimension m=3.

Here the dimension of the world X is m=3, and a 3-dimensional simplex is used as an aid for creating the unit vectors and gaining information regarding the vertices and faces of the Voronoi cell. As in the case of dimension m=2, one can implement this method using loops instead of recursion, using the data structure called FaceList, with the difference that now, in the three-dimensional case, each subface is represented by a set of three unit vectors, which are in the direction of its corners. The structure is simply a list of subfaces, and the process runs until the list is empty. The initial list contains the faces of the simplex.

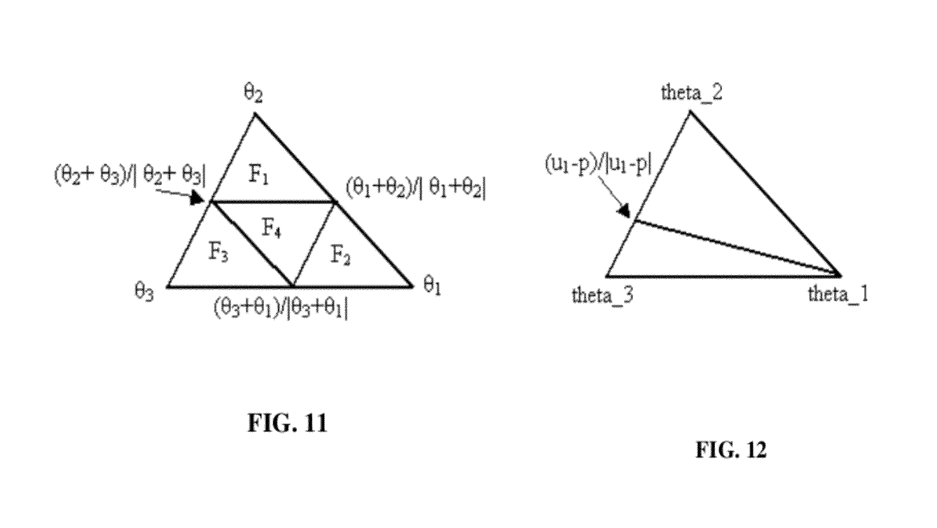

Reference is now made to FIGS. 11-18, which illustrate various aspects of the Voronoi diagram calculation for the three-dimensional case.

FIG. 11 shows a small diameter partition of a subface of a 3D simplex and its sub-faces, for the method of FIG. 3B for computing the Voronoi cells in the 3-dimensional case.

FIG. 12 shows an example of a boundary point partition of type 1 of a subface of a 3D simplex and its sub-faces for the method of FIG. 3B in the 3-dimensional case. There are 2 subfaces, and in this example u₁ is outside the cell.

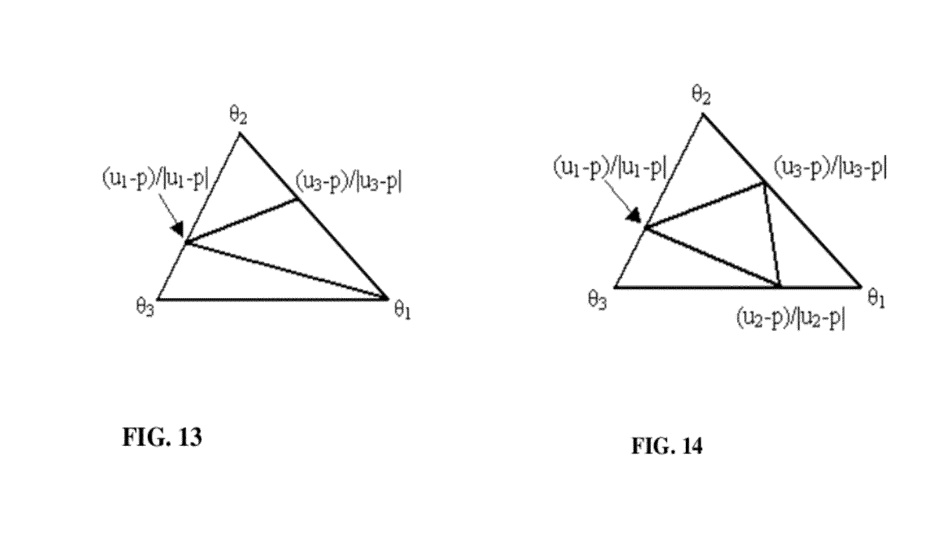

FIG. 13 shows an example of a boundary point partition of type 2 of a subface of a 3D simplex and its sub-faces for the method of FIG. 3B in the 3-dimensional case. There are 3 subfaces. In this example u₁ and u₃ are outside the cell.

FIG. 14 shows an example of a boundary point partition of type 3 of a subface of a 3D simplex and its sub-faces for the method of FIG. 3B in the 3-dimensional case Here u₁, u₂, and u₃ are outside the cell.

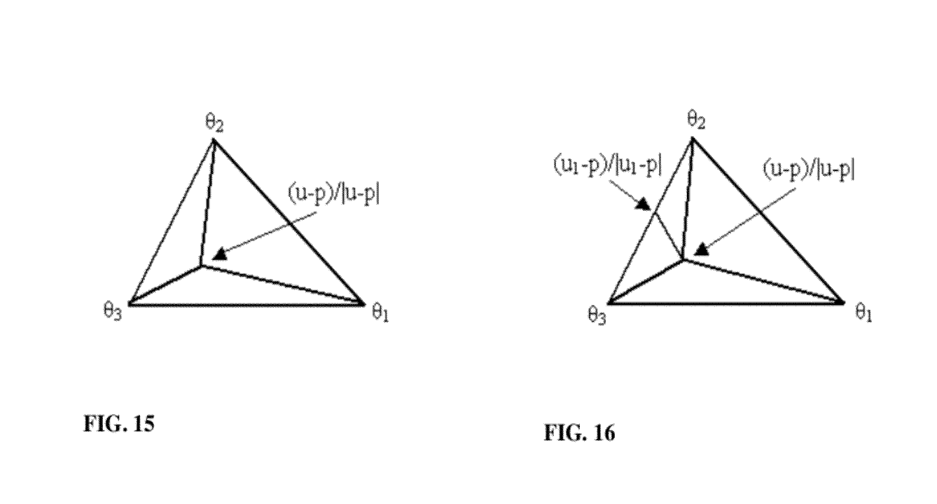

FIG. 15 shows an example of an interior point partition of type 0 of a subface of a 3D simplex and its sub-faces for the method of FIG. 3B in the 3-dimensional case.

FIG. 16 shows an example of an interior point partition of type 1 of a subface of a 3D simplex and its sub-faces for the method of FIG. 3B in the 3-dimensional case. In this example u₁ is outside the cell.

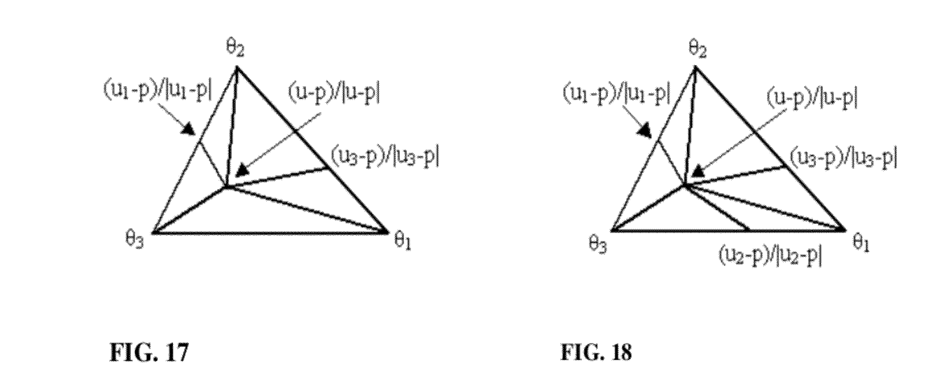

FIG. 17 shows an example of an interior point partition of type 2 of a subface of a 3D simplex and its sub-faces for the method of FIG. 3B in the 3-dimensional case. In this example u₁ and u₃ are outside the cell.

FIG. 18 shows an example of an interior point partition of type 3 of a subface of a 3D simplex and its sub-faces for the method of FIG. 3B in the 3-dimensional case. In this example u₁, u₂, and u₃ u_{—}3 are all outside the cell.

In all of these figures a face of a 3-dimensional simplex is shown (as seen from above) and it is partitioned into several subfaces, according to the specific case it treats. Each such partition has a name which is used below, e.g., “an interior point partition of type 1”. It should be emphasized again that the simplex is used (conceptually) for creating the unit vectors, but these unit vectors are only in the direction of the corners of a given subface, and they are not necessarily on the same plane as the one on which the subface is located. Despite this, it is convenient to represent a subface by its associated unit vectors.

The following terminology is used: when a certain partition (e.g., “a small diameter partition”) is applied to some given subface F, then one is done with F and continues with the other subfaces.

A pseudocode method for the 3D case is as follows:
1. Create the simplex unit vectors and call them φᵢ, i=1,2,3,4; Create the simplex faces;
2. Repeat the following (until the end) for each desired site Pₖ and each desired point p in Pₖ.
3. Enter the simplex faces into FaceList;
4. Let θᵢ=φᵢ, i=1,2,3 and choose the face F={θ₁,θ₂,θ₃}; [simply an Initialization]
   5. Repeat the following (until the end) while FaceList is nonempty:
   6. If det(θ₁, θ₂, θ₃)=0, then we are done with the face F, i.e., remove F from FaceList [because F is degenerate]; Continue with the next subface in FaceList;
7. Else (until the end), let Tᵢ=T(θᵢ,p)θᵢ; Compute the endpoints p+Tᵢi=1,2,3; Find a neighbor site gᵢ, i=1,2,3 (or a point in it if a site has more than one point) to p+Tᵢ; Compute the bisecting plane Lᵢ between p and gᵢ,i=1,2,3; If no gᵢ exists for some i, then p+Tᵢ is on the boundary of the world. Call Lᵢ to the corresponding boundary plane;
8. Check the real number of planes by checking if the 3 endpoints are on the same plane (e.g., by checking if p+Tᵢ, i=1,3 are on L₂), or on 2 different planes, or on 3 different planes [to avoid problems later, since a point can be on several planes]; Change the planes Lᵢ associated with p+Tᵢ accordingly;
9. Let B_{H} be the matrix composed of B with an additional (right) column H (where H is defined after equation (*)), and consider equation (*).
10. If rank(B)<rank(B_{H}) [no solutions to equation (*), namely not enough information regarding possible vertices in the cone], then make a “small-diameter partition” of F; Enter the resulting subfaces into FaceList and remove F from it; We are done with F;
11. Else (until the end), from now on rank(B)=rank(B_{H}), and there are three possible cases:
12. Case 1, rank(B)=1: [in this case all the planes are the same] Check if one of the endpoints p+Tᵢ, i=1,2,3 is a vertex by checking if it was obtained by at least 3 bisecting planes (including the faces of the boundary of world if it is on such faces), and if yes, then store it; We are done with F anyway (even if the endpoints are not vertices);
13. Case 2, rank(B)=2:
   This case happens only when two planes are the same and the third is different. By stage 8 the endpoint corresponding to the different plane is not on the same plane as the other two endpoints.
      A. Check if one of the endpoints p+Tᵢ, i=1,2,3 is a vertex by checking if it was obtained by at least 3 bisecting planes (including all the faces of the boundary of the world if it is on such faces), and store it if yes.
      B. Put λ₁=0, and check whether the system (*) has a nonnegative solution of the form (0, λ₂, λ₃), i.e., one needs to solve a system of two unknowns and two equations (recall that in the canonical form of the matrix
         the third equation is 0=0) [Geometric meaning: the line of intersection Λ of the two planes L₂, L₃ passes via the face X₁=0 of the cone].
         Check also if there are nonnegative solutions of the form (λ₁, 0, λ₃) and (λ₁,λ₂,0). Let NumLambda be the number of all of these solutions.
      C. If NumLambda=0, then there is no nonnegative solution of the above form. Make a “small diameter partition” of F [the line Λ is not in the cone:
   not enough information] and continue with these subfaces;
      D. Else, from now on NumLambda>0. Let (λ₁,λ₂,λ₃) be a nonnegative solution corresponding to some λᵢ=0, and let uᵢ=p+λ₁T₁+λ₂T₂+λ₃T₃; check whether uᵢ is in the Voronoi cell of p, and along the way find all the bisecting planes corresponding to uᵢ; If uᵢ has at least 3 bisecting planes, then uᵢ is a vertex. In this case store uᵢ;
   Now there are several possible sub-cases:
      a) NumLambda=1:
         i. If (the unique) uᵢ is in the cell, then make a “small diameter partition” of F.
         ii. Else, make a “boundary point partition of type 1” of F corresponding to uᵢ;
      b) NumLambda=2:
         i. If the two uᵢ are the same, then go to the case NumLambda=1.
         ii. If both of the two different uᵢ are in the cell of p, then we are done with the face F.
         iii. If both of the two different u_i are outside the cell of p then make a “boundary point partition of type 2” of F corresponding to these uᵢ;
         iv. If there is one uₖ in the cell of p and one different uᵢ outside the cell, then make a “boundary point partition of type 1” of F corresponding to uᵢ;
      c) NumLambda=3: it must be that among the uᵢ, uⱼ, uₖ, two are the same, and they are different from the additional one.
   Hence this is actually the case NumLambda=2, and so (after finding the two different ones) do what written there;
14. Case 3, rank(B)=3:
   The system (*) has a unique solution λ=(λ₁, λ₂,λ₃).
   If is not nonnegative, then make a “small diameter partition” of F;
   Else, from now on X is nonnegative. Let u=p+λ₁T₁+λ₂T₂+λ₃T₃;
   Check whether u is inside the Voronoi cell of p and along the way find all the bisecting planes corresponding to u.
      A. If u is not inside the cell of p (also in the case where u is outside the world), then u is not a vertex of the cell;
         Make an “interior point partition of type 0” of F.
      B. Else, from now on u is inside the cell, and hence u is a vertex of the cell, but additional checks are needed for not missing other vertices corresponding to F; Store u;
      C. Let S₁ be the intersection of L₂, L₃, let S₂ be the intersection of L₃ and L₁, and let S₃ be the intersection of L₁ and L₂;
         Each Sᵢ is a line which has the parametric representation {u+tQᵢ: t is real} where Qᵢ is the cross product of Nⱼ and Nₖ, i,j,k are all different, and Nⱼ is the normal to the plane Lⱼ;
         Find the point of intersection uᵢ=u+tQᵢ of Sᵢ and the plane which passes via p whose normal M is the cross product of Tⱼ and Tₖ; [this is the plane passing via p and generated by Tⱼ,Tₖ. The formula for t is t=<p−u,M>/(<N,Qᵢ>)]
      D. Check whether uᵢ-p is in the non-negative cone generated by T₁,T₂,T₃; Let NumU be the number of uᵢ such that both uᵢ-p is in the non-negative cone generated by T₁,T₂,T₃ and that uᵢ is outside the Voronoi cell of p (along the way find all the bisecting planes corresponding to uᵢ; for checking if uᵢ-p is in the nonnegative cone generated by T₁,T₂,T₃ it suffices to check that uᵢ-p is in the nonnegative cone generated by Tⱼ,Tₖ, where j,k are different from i, and this may be done by checking if a corresponding linear system has a nonnegative solution); For any uᵢ which is inside the cell and has at least 3 bisecting planes, store uᵢ;
      E. If all the 3 points uᵢ are inside the cell of p and all the 3 points uᵢ-p, i=1,2,3 are in the nonnegative cone generated by T₁,T₂,T₃, then we are done with F; [there are no other vertices corresponding to F]
      F. Else,
         a) If NumU=1,2 or 3, then
            i. If u=θᵢ for j=1,2 or 3 (one of the corners of the subface F), then make a “boundary point partition of type NumU” of F corresponding to the above points uᵢ associated with NumU;
            ii. Else, make an “interior point partition of type NumU” of F corresponding to above points uᵢ associated with NumU;
         b) Else
            i. If u=θᵢ for j=1,2 or 3, then make a make “a small diameter partition” of F.
            ii. Else, make “an interior point partition of type 0” of F.

Storing the data and obtaining combinatorial information and additional information

The following explains schematically how the data may be stored, with reference again to FIG. 3E, and how to retrieve combinatorial information and additional information related to the Voronoi cells and more. Here the dimension of the region X can be general.

Given a point p in some site Pₖ, when a vertex u from the cell of p is found, one stores the following features: its coordinates, the hyperplanes from which it was obtained (i.e., u belongs exactly to the corresponding faces located on these hyperplanes), the point p and the index k. For storing a hyperplane L it is convenient to store the index of its associated neighbor site, namely the index (number) of the site which induces it. If it is a boundary hyperplane, then it has a unique index number which is stored and from this index one can retrieve the parameters (the normal and the constant) defining the hyperplane. Alternatively, these parameters can be stored directly. For some purposes it may be useful to store also some endpoints associated with each hyperplane. A convenient data structure for storing the whole diagram is a two dimensional array, indexed by p and k, in which the vertices (represented, as explained above, by coordinates and associated neighbor sites) and any additional information, such as endpoints, are stored.

If one wants to compare two hyperplanes, then one can simply compare the index of the associated neighbor site/boundary hyperplane. If one needs additional information on the hyperplane, then this information can be retrieved immediately because the hyperplane is perpendicular to the segment [p,a] and passes via the middle point of this segment (a is the given neighbor); in the case of a boundary hyperplane from its index one retrieves the parameters which are stored in a different list.

In dimension m=2 a vertex is always obtained from 2 lines. In dimension m≦3 a vertex is usually obtained from exactly m hyperplanes, but in principle it can be obtained from S hyperplanes, where S>m. The set {L_{i_{—}1}, . . . , L_{i_S}} of all the hyperplanes from which u was obtained is referred to herein as the combinatorial representation of u.

As the examples below show, once the above information is stored, one can obtain any other combinatorial information related to the cell of p, say the neighbors of a given vertex, the edges of some cell, and so on, and hence one does not need to store these types of data separately. This is in contrast to familiar methods of representing a combinatorial information related to the Voronoi diagram, in which one has to find and store all the j-dimensional faces, j=0, 1, . . . , m−1 of the cell.

### Example 1

The neighbors (in the same cell) of some given vertex u with a given combinatorial representation are all the vertices v for which m−1 of their hyperplanes in their combinatorial representation coincide with those of u.

### Example 2

Given some hyperplane Lᵢ, all the vertices v with Lᵢ in their combinatorial representation are the vertices of the face of the cell of p corresponding to Lᵢ (i.e., this face is located on Lᵢ). This face is denoted by Lᵢ again. This is an (m−1)-dimensional polygon. Suppose one wants to find all the (m−2)-dimensional faces of Lᵢ. One chooses some Lⱼ, j≠i belonging to some vertex on Lᵢ, and looks at all the vertices with Lᵢ and Lⱼ in their representation. These vertices create an (m−2)-dimensional face of Lᵢ, and by repeating the process with the other Lⱼ's one finds all the other (m−2)-dimensional faces. In general, given some different hyperplanes L_{i_{—}1}, . . . , L_{i_S}, all the vertices with L_{i_{—}1}, . . . , L_{i_S} in their representation create an (m-S)-dimensional face of the cell.

### Example 3

Given the vertices of a two dimensional face (possibly in a three dimensional cell), suppose one wants to arrange them in counterclockwise order. Let u₁ be some vertex with {Lᵢ,Lⱼ} as its representation. One finds the other vertex u₂ with Lⱼ in its representation. Suppose that {Lⱼ,Lₖ} is the representation of u₂. One then finds the other vertex u₃ with Lₖ in its representation and so on. One now has a list u₁, . . . , u_{N} of all the vertices of the cell in either clockwise or counterclockwise order. To decide which order was obtained one can check the sign of the expression D=det(u₁−u₂,u₂−u₃): if D>0, then this a counterclockwise order, and if D<0, then this is a clockwise order (and hence one reverses the order of the list of vertices).

### Example 4

When the two dimensional face in the method described in a previous example is the cell itself, another method can be used in order to obtain a counterclockwise order. One gives a sorting value to each endpoint and at the end sorts the vertices in increasing or decreasing order according to their sorting value. The sorting value is obtained as follows: the 3 initial directions φᵢ, i=1, 2, 3 have the sorting values 1,2,3 respectively. Then, if θ₁ and θ₂ are two directions from which an intermediate unit vector θ₃ is created, then the sorting value s₃ of θ₃ is defined as s₃=(s₁+s₂)/2 where sᵢ is the value associated with θᵢ, i=1,2 (or another an intermediate value between s₁ and s₂).

### Example

Suppose that the sites are points. Given a vertex u in the cell of some site Pₖ, for finding all of its neighbor vertices in the entire diagram one may proceed by finding all the vertices v in the entire diagram for which (m−1) of the hyperplanes in their representation coincide with those of u.

### Example

The convex hull of a set of points is the minimal convex set which contains them. Suppose that the sites are points. The convex hull can be generated by a subset of the given sites composed of all the sites whose cells are not bounded. Hence, to find all the generating sites one needs to take a large enough region X and to check all the sites whose cells contain a face which is on the boundary of X. After finding these sites one knows that they are on the boundary of the convex hull and the rest of the sites are in the interior of the convex hull.

### Example

Once the faces are known, one can represent the cells using many endpoints by adding them in a fast way. Suppose one wants to add r≧1 endpoints on each face.
1. If the dimension m is 2: suppose that L={x: <N,x>=c} is the line on which the face is located, and let p+T_{—}1, p+T_{—}2 be the corners of the face. For any j, 1≦j<r, let φ_j=(T_{—}1+(j/r)(T_{—}2−T_{—}1))/|T_{—}1+(j/r)(T_{—}2-T_{—}1)| and t=(c−<N,p>)/(<N,φ_j>). The point p+t.φ_j is an endpoint located on the given face.
2. If m>2: Let L={x: <N,x>=c} be the (hyper)plane on which the face is located. For each i=1, . . . , m and each j, 1≦j<r do the following:
   Let D_i=(T_{—}1+ . . . +T_m)−T_i.
   Let S=((1−(j/r))/(m−1))D_i,
   Let φ_ij=((j/r)T_i+S)/|(j/r)T_i+S|
   [interpretation: a (normalized) convex combination of T_i and the center of mass of the other T_k].
   Add the endpoint p+t.φ_ij, where t=(c−<N,p>)/(<N,φ_ij>).

Computing the Delaunay Graph (Delaunay Tessellation)

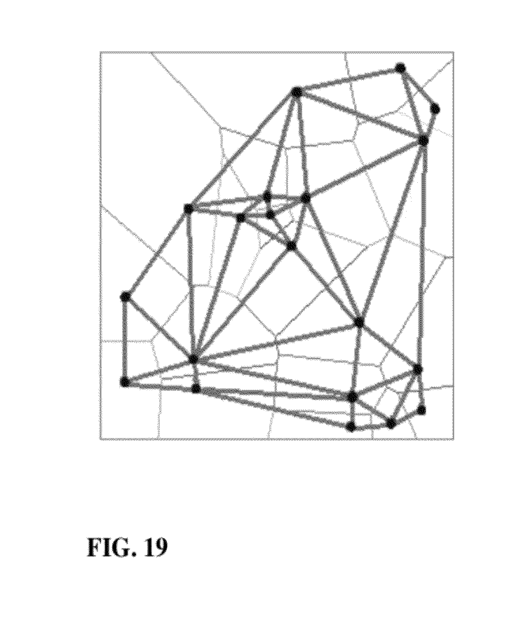

Referring now to FIG. 19 and also to the flow chart of FIG. 3F, here it is explained how to compute the Delaunay graph (the Delaunay tessellation) of the given sites. The Delaunay tessellation is an important geometric structure which by itself has many applications.

Suppose that the sites Pᵢ, . . . , Pₙ are points. By definition, the Delaunay graph consists of vertices and edges. The vertices of the Delaunay graph are the sites. There is an edge between two sites if their Voronoi cells are neighbors (via a face). FIG. 19 illustrates the graph in dimension 2. The Delaunay graph shown is of 20 sites in the plane (thick line). The Voronoi cells of the same sites are shown as well in thin line.

As a result, for computing the Delaunay graph one chooses a given site, goes over the data structure used for storing the Voronoi cells as explained hereinabove, and finds all the different neighbor sites of a given site. The procedure is repeated for each site. For drawing the Delaunay graph one simply connects two sites by an edge when it is found that one site is a neighbor site to another one.

### Additional Notes

In this section the following additional notes relate to the implementation of the methods described hereinabove.
1. If the world X is a polygon, then the intersection of some ray in the direction of θ with the boundary (needed in Method:Endpoint}), can be easily found. One simply goes over the faces of the world (the i-th face is represented as <Nᵢ,x>=cᵢ) and check if p+tθ is on the i-th face by checking if both t=(cᵢ−<Nᵢ,p>)/(<Nᵢ,θ>) is positive and p+tθ is in the world. The process stops at the first face satisfying the above.
2. If some site Pₖ has more than one point, then one treats each of the cells of its points separately. There are situations in which one wants to consider only points which are on the boundary of the Voronoi cell of Pₖ. In particular, one has to be sure to remove vertices which are actually internal points. Here is a simple way to check if a point E=p+tθ which is known to be an endpoint (e.g., a vertex) is on the boundary of the cell when Pₖ has more than one point: one compares t=d(E,p) to d(E,q) for any q in Pₖ. If t<d(E,q) for some q, then E is not a boundary point. Otherwise E is a boundary point.
3. The initial unit vectors: in dimension m=2 they can be taken as φ₁=(0.5√3,−0.5), φ₂=(0,1), φ₃=(−0.5√3,−0.5). In dimension m=3 they can be taken as φ₁=(1,0,0), φ₂=(−⅓, (√8)/3,0), φ₃=(−⅓,−(√2)/3,(√6)/3), φ₄=(−⅓,−(√2)/3,−(√6)/3).
4. One should go over the final list of vertices to check for redundancy, because a vertex may be found more than one time.
5. Error parameters: for significantly reducing problems related to numerical errors, it is recommended to use error parameters. Here are some examples:
   a) When checking if two real numbers a and b are identical, one checks whether |a−b|<ε₁ for some small error parameter ε₁. Similary, when checking if two vectors a and b are identical, we check if the norm |a−b|<ε₂, where one can take the Euclidean norm, the max norm or any other norm.
   b) When checking if a 3 by 3 matrix in the canonical form has rank 2, one can check whether the norm |R| of the third line R satisfies |R|<ε₃.
   c) When checking if the components λᵢ of λ=(λ₁,λ₂,λ₃) are nonnegative, one first checks whether |λᵢ|<ε₄ for some i, and if yes, then regards this λᵢ as 0.
   d) For checking if some determinate D vanished, one checks if |D|<ε₅.
      All of these parameters εᵢ are quite small (say 10̂{−7} or 10̂{−10}), but they are not necessarily identical, and their magnitude may change according to the floating point arithmetic and the number of sites.
6. To check if a vertex v (or an endpoint) is obtained by more than 3 planes the following procedure can be used: d(v,p) and d(v,a) are compared for any a in the other sites(possibly using enhancements); then all the points a satifying d(v,a)=d(v,p) are stored. If eventually d(v,p)≦d(v,a) for any a, then those points a satisfying d(v,a)=d(v,p) are the neighbors of v, and the corresponding bisectors between those a and p are the planes from which v was obtained. This can be done during finding the endpoint (Method:Endpoint}), in the corresponding step in which a similar comparison is made.
7. Many calculations, e.g., the computation of endpoints, vertices or faces can be saved because they have already been made in previous stages of the computation (of a certain cell or previous cells).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A computerized method of decomposing a given region X into cells, the decomposition being induced by a set of sites P₁, . . . , Pₙ, and a distance function d, and finding for each desired site Pₖ a cell, the cell comprising a set of all the points in X satisfying a distance inequality condition, based on said distance function, the inequality of the condition being that the distance of a respective point to said site Pₖ is not greater than the distance of said respective point to the union of the other sites, the method being carried out on an electronic processor and comprising:
a) selecting a desired site Pₖ and a desired point p in this site;
b) selecting a plurality of subfaces corresponding to a manifold around said point p;
c) for each desired subface selecting a plurality of directions;
d) for each direction providing a ray, selecting a point on the ray as an endpoint, and selecting hyperplanes corresponding to the endpoints;
e) for each desired subface determining a type of intersection between the detected hyperplanes;
f) determining whether there exist vertices of the cell in a cone generated by the endpoints, and finding said vertices, wherein if there remain further vertices that have not been found then there is carried out a step of further dividing the said subface into additional subfaces for separate determination;
g) storing information relating to said vertices;
h) repeating a)-g) for each desired site Pₖ and each desired point p in the selected site;
i) defining at least one vertex or hyperplane from said endpoints, thereby decomposing said region X; and
j) outputting said decomposed region X in a machine readable format.

2. The method of claim 1, further comprising applying said decomposed region to one member of the group comprising: controlling a communications network, managing a communication network, controlling a robot, managing a robot, modeling, testing or simulating a three-dimensional network, controlling a three-dimensional network, testing or modeling a material, data searching, searching for data on a network or database, image processing, mesh generation and re-meshing, curve and surface generation, curve and surface reconstruction, solid modeling, collision detection, controlling motion of vehicles, navigation, accident prevention, data clustering and data processing, proximity operations, nearest neighbor search, numerical simulations, weather prediction, analyzing or modeling proteins, analyzing or modeling crystal growth, analyzing or processing digital or analog signals, analyzing or modeling biological structures, designing drugs, finding shortest paths, pattern recognition, rendering, data compression, providing overall control of a plurality of methods for image processing, providing overall control of a plurality of methods for data categorization, providing overall control for a plurality of methods for data clustering, designing and testing of electronic circuits, management of geographic information systems, computing geometric objects, locating a resource according to the solution of an efficient location problem, face recognition, analyzing the behavior of populations, analyzing or modeling data related to astronomy, analyzing or modeling data related to geography, detecting or analyzing geometric structures, detecting or analyzing space structures, location based services, analyzing atmospheric data, analyzing oceanographic data, analyzing traffic, detecting or analyzing the distribution of matter in a region, detecting or analyzing the distribution of populations in a region, detecting or analyzing the distribution of energy in a region, and an artistic tool.

3. The method of claim 1, comprising, in d) additionally selecting neighbour sites that correspond to said hyperplanes.

4. The method of claim 1, wherein said determining said type comprises examining a predetermined system of equations.

5. The method of claim 4, wherein said determining of vertices in said cone comprises further examining said predetermined system of equations.

6. The method of claim 1, wherein said manifold is a simplex.

7. The method of claim 1, wherein a subface to be selected is determined by one member of the group consisting of corners and unit vectors corresponding to said corners.

8. The method of claim 4, wherein said predetermined system of equations is of the form
Bλ=H,
wherein:
m is the dimension of said region X;
θᵢ, are said direction unit vectors;
p+Tᵢ is said endpoint in direction θᵢ;
Tᵢ=T(θᵢ,p)θᵢ is the vector whose direction is θᵢ and whose length is the distance between said point p and said endpoint p+T_i;
L_i is the hyperplane corresponding to the endpoint p+Tᵢ;
Nᵢ is a normal to the hyperplane Lᵢ;
λ=(λ₁, . . . , λₘ) is a vector of unknowns;
B is an m by m matrix with Bᵢⱼ=<Nᵢ,Tⱼ>, i,j=1, 2, . . . , m; and
H=(H₁, . . . , Hₘ) is the vector with Hᵢ=<Nᵢ,Tᵢ>, i=1, 2, . . . , m.

9. The method of claim 8, further comprising:
computing respective vertices by solving said predetermined system of equations to obtain a solution λ=(λ₁, . . . , λₘ), and
checking if a corresponding vector u=p+λ₁T₁+ . . . λₘTₘ, comprising said vectors T₁, . . . , Tₘ and said point p, is in said cone and in said cell wherein m is the dimension of said region X.

10. The method of claim 1, wherein said region X is of dimension two, wherein said dividing said given subface into additional subfaces comprises choosing an intermediate vector between respective corners of said subface to create two new subfaces, each new subface comprising said intermediate point and one of said corners, or vectors in a direction of said corners.

11. The method of claim 8, wherein said region X is of dimension two and wherein said deciding whether there are vertices of the cell in said cone generated by said endpoints comprises checking one member of the group consisting of:
a number of said hyperplanes,
whether there exist nonnegative solutions to said system of equations,
whether the determinant of said matrix B vanishes or not,
whether there are infinitely many solutions, a unique solution or no solution at all to said system of equations.

12. The method of claim 1, wherein said region X is of dimension three and said dividing said given subface into additional subfaces comprises dividing said subface into a partition of additional subfaces, where said partition is chosen from the following list of possible partitions:
no partition at all,
a small diameter partition′,
an interior point partition of type 0,
an interior point partition of type 1,
an interior point partition of type 2,
an interior point partition of type 3,
a boundary point partition of type 1,
a boundary point partition of type 2, and
a boundary point partition of type 3.

13. The method of claim 8, wherein said region X is of dimension three and said deciding whether there are vertices of the cell in said cone generated by said endpoints comprises one member of the group consisting of:
checking the number of different hyperplanes,
checking whether there exist nonnegative solutions to said system of equations,
checking whether said matrix B is of rank 1, or rank 2, or rank 3, or of rank smaller than the rank of another matrix B_{H}, or
checking whether there are infinitely many solutions, unique solution or no solution at all to said system of equations.

14. The method of claim 1, wherein the computations are carried out to a predetermined level of error parameters.

15. The method of claim 1, comprising reusing cell calculations of earlier stages for saving calculations in later stages.

16. The method of claim 1, wherein said computation of a respective endpoint in a given direction θ comprises:
selecting a point y along the corresponding ray in direction θ, and moving and testing y recursively, and until a stopping condition is satisfied:
recursively testing comprises: selecting a point y along the ray emanating from p and in cases of y being either on the boundary of said region X or outside the cell of p; then if y is on the boundary, defining L as a corresponding hyperplane on which y is located and checking whether y is in said cell; and if y is in said cell, selecting y as an endpoint and defining L as the corresponding bisecting hyperplane on which y is located; and
wherein if y is neither within said cell of p nor on a boundary of region X, finding a corresponding point closer to y than to p, and determining an intersection u between the ray and a corresponding hyperplane L then setting y:=u, recursively testing until y is in said cell of p then setting y as the endpoint, said corresponding point being a closest neighbor site or a point in said closest neighbor site, and L being the corresponding bisecting hyperplane.

17. A computerized method for storing computed Voronoi cells and retrieving combinatorial information related to said cells to an electronic storage device, the method comprising:
storing, in said storage device, for each desired site Pₖ and each desired point p, data relating to a desired vertex u belonging to the cell of said point p together with data relating to an associated hyperplane; and
using said information to obtain information about said cells.

18. The method of claim 17, wherein said associated hyperplane is a hyperplane on which is located a face belonging to said cell of said point p.

19. The method of claim 18, wherein said data relating to desired vertex comprises the coordinates of said desired vertex and said data relating to said associated hyperplane comprises at least one member of the group comprising: associated neighbor sites, associated bisecting hyperplanes, associated faces located on said hyperplanes, and endpoints.

20. The method of claim 17, further comprising applying said combinatorial information to one member of the group comprising: controlling a communications network, managing a communication network, controlling a robot, managing a robot, modeling, testing or simulating a three-dimensional network, controlling a three-dimensional network, testing or modeling a material, data searching, searching for data on a network or database, image processing, mesh generation and re-meshing, curve and surface generation, curve and surface reconstruction, solid modeling, collision detection, controlling motion of vehicles, navigation, accident prevention, data clustering and data processing, proximity operations, nearest neighbor search, numerical simulations, weather prediction, analyzing or modeling proteins, analyzing or modeling crystal growth, analyzing or processing digital or analog signals, analyzing or modeling biological structures, designing drugs, finding shortest paths, pattern recognition, rendering, data compression, providing overall control of a plurality of methods for image processing, providing overall control of a plurality of methods for data categorization, providing overall control for a plurality of methods for data clustering, designing and testing of electronic circuits, management of geographic information systems, computing geometric objects, locating a resource according to the solution of an efficient location problem, face recognition, analyzing the behavior of populations, analyzing or modeling data related to astronomy, analyzing or modeling data related to geography, detecting or analyzing geometric structures, detecting or analyzing space structures, location based services, analyzing atmospheric data, analyzing oceanographic data, analyzing traffic, detecting or analyzing the distribution of matter in a region, detecting or analyzing the distribution of populations in a region, detecting or analyzing the distribution of energy in a region, and an artistic tool.

21. The method of claim 17, further comprising finding, from said stored data, different neighbors of each site p;
computing therefrom a Delaunay tessellation; and
passing an edge between each site p and each of its different neighbor sites.

22. The method of claim 21, further comprising applying said Delaunay tessellation to one member of the group comprising: controlling a communications network, managing a communication network, controlling a robot, managing a robot, modeling, testing or simulating a three-dimensional network, controlling a three-dimensional network, testing or modeling a material, data searching, searching for data on a network or database, image processing, mesh generation and re-meshing, curve and surface generation, curve and surface reconstruction, solid modeling, collision detection, controlling motion of vehicles, navigation, accident prevention, data clustering and data processing, proximity operations, nearest neighbor search, numerical simulations, weather prediction, analyzing or modeling proteins, analyzing or modeling crystal growth, analyzing or processing digital or analog signals, analyzing or modeling biological structures, designing drugs, finding shortest paths, pattern recognition, rendering, data compression, providing overall control of a plurality of methods for image processing, providing overall control of a plurality of methods for data categorization, providing overall control for a plurality of methods for data clustering, designing and testing of electronic circuits, management of geographic information systems, computing geometric objects, locating a resource according to the solution of an efficient location problem, face recognition, analyzing the behavior of populations, analyzing or modeling data related to astronomy, analyzing or modeling data related to geography, detecting or analyzing geometric structures, detecting or analyzing space structures, location based services, analyzing atmospheric data, analyzing oceanographic data, analyzing traffic, detecting or analyzing the distribution of matter in a region, detecting or analyzing the distribution of populations in a region, detecting or analyzing the distribution of energy in a region, and providing an artistic tool.
